(19) United States
(12) Patent Application Publication
(10) Pub. No.: US 2023/0040347 A1
(43) Pub. Date: Feb. 9, 2023

(54) DYNAMIC CONTROL PANEL INTERFACE MECHANICS FOR REAL-TIME DELIVERY OPERATION MANAGEMENT SYSTEM

(71) Applicant: SHMOODLE INC., San Francisco, CA (US)

(72) Inventor: Jack Zante HAYS, San Francisco, CA (US)

(21) Appl. No.: 17/783,253

(22) PCT Filed: Dec. 11, 2020
(86) PCT No.: PCT/US20/64712

§ 371 Date: Jun. 7, 2022

Related U.S. Application Data
(60) Provisional application No. 62/946,541, filed on Dec. 11, 2019.

(51) Int. Cl. G06Q 10/08; G06F 3/04842; G06F 3/0486

(52) U.S. Cl. CPC G06Q 10/08355; G06F 3/04842; G06F 3/0486

(57) ABSTRACT

A real-time delivery operation management system, primarily for local or last mile delivery services to consumers. A management interface works in tandem with an instant delivery route-making algorithm to visualize the route plan for hired or contracted couriers in a dynamic interface, allowing depot managers to view or alter the delivery plan in real time. Visible route paths connect the depot, couriers, and their relevant orders for both assigned and offered routes. Orders can be selected and dragged and dropped to reconfigure routes and assignment of orders to couriers. Orders can be drag-and-dropped on either existing routes, couriers, or depots and thereby instantiate any of the underlying management operations.

### CROSS REFERENCE TO RELATED APPLICATIONS

This application claims the benefit of priority pursuant to 35 U.S.C. § 119(e) of U.S. provisional application No. 62/946,541 filed 11 Dec. 2019 entitled “Dynamic control panel with drag-and-drop interface mechanics for automatic or manual real time management of an instant-delivery operation,” which is hereby incorporated herein by reference in its entirety.

### TECHNICAL FIELD

The technology described herein relates to real-time management of delivery or courier services using integrated computer and telecommunications systems.

### BACKGROUND

Presently most courier services are independent of the customers they serve. For example, while some restaurants (e.g., serving pizza and Asian food) have traditionally hired employees to provide food delivery to customer's homes or businesses, most restaurants do not have their own private delivery service. Those restaurants that do, typically provide their drivers with delivery information (e.g., customer addresses) written on paper or via a text message. The driver then uses personal geographic knowledge or, more recently, mapping software on a mobile computing device, to plot a route for the delivery.

In recent years, third party delivery services have been created to service the restaurant industry for food delivery. These services often provide an interface for scheduling and paying for food delivery, either as a standalone software application on a mobile computing device or via a web page accessible over the internet on using a computer with an internet connection. Specific implementation of the delivery process depends on the service used. In one system, the customer may be able to both order and pay for food and further schedule delivery through the delivery service platform. The delivery service communicates the order to the restaurant, provides payment, collects its service fee, and manages drivers for pickup and delivery of the orders. In another implementation, the customer orders food directly from the restaurant and then accesses the delivery service platform to schedule pickup and delivery separately. The delivery service dispatches and manages its fleet of drivers to complete pickup and delivery. In yet another implementation, the customer orders food directly from the restaurant and the restaurant accesses the delivery service platform to schedule pickup and delivery separately. The delivery service dispatches and manages its fleet of drivers to complete pickup and delivery. In each instance, the delivery service is separate from the restaurant and collects a service fee. Neither the customer nor the restaurant has control over the fees charged by the delivery service. Further, the restaurant has no control over the scheduling and prioritization of the deliveries.

As shopping for other goods over the internet has become more readily available and easily accessible (e.g., groceries), other brick and mortar stores are finding it desirable to offer products online and provide the convenience of local delivery to their customers. Such local businesses would also like to take advantage of such delivery services to better compete with massive online retailers (e.g., Amazon, Wal-Mart), which often have their own local delivery fleet staffed by both employees and independent contractors. However, small, local businesses do not have the customer or sales volume to implement their own delivery services. These small businesses are starting to use the third party delivery services presently used by restaurants, as well as private carriage services (e.g., Uber, Lyft), in order to serve their customers. However, as with restaurants, other small businesses have no control over the fees charged by the delivery services or the scheduling and prioritization of the deliveries.

The information included in this Background section of the specification, including any references cited herein and any description or discussion thereof, is included for technical reference purposes only and is not to be regarded subject matter by which the scope of the invention as defined in the claims is to be bound.

### SUMMARY

A real-time delivery operation management system is disclosed primarily for local or last mile delivery services to consumers. A management interface works in tandem with an instant delivery route-making algorithm to visualize the route plan for hired or contracted couriers in a dynamic interface, allowing depot managers to view or alter the delivery plan in real time. Visible route paths connect the depot, couriers, and their relevant orders for both assigned and offered routes. Orders can be selected and dragged and dropped to reconfigure routes and assignment of orders to couriers. Orders can be drag-and-dropped on either existing routes, couriers, or depots and thereby instantiate any of the underlying management operations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

The disclosure will be readily understood by the following detailed description in conjunction with the accompanying drawings, wherein like reference numerals designate like structural elements.

FIG. 1 is a schematic diagram of a networked environment in which the real-time delivery management system is implemented.

FIGS. 2A and 2B are schematic diagrams of mobile telephones with GPS tracking capability implementing a courier assignment and routing application that is part of the platform of the real-time delivery management system.

FIG. 3 is a screen capture of an example GUI interface displaying a courier management application that is part of the platform of the real-time delivery management system.

FIGS. 4-6 are a series of sequential screen captures depicting an intuitive order assignment operation as provided by the courier management application.

FIGS. 7A-8B are a series of sequential screen captures depicting an intuitive order transfer operation between carriers as provided by the courier management application.

FIG. 9 is an example schematic representation of a route distance calculation table underlying the functionality of a neural network routing model used by the real-time delivery management system.

FIGS. 10-20 are together an integrated, extended flow diagram of a computer system implementation of mechanics providing a dynamic control panel interface for a real-time delivery operation management system.

FIG. 21 is a schematic diagram of a general purpose mobile computing device that may be used in the implementation of a real-time delivery operation management system.

FIG. 22 is a schematic diagram of a general purpose computer system that may be used in the implementation of a real-time delivery operation management system.

### DETAILED DESCRIPTION

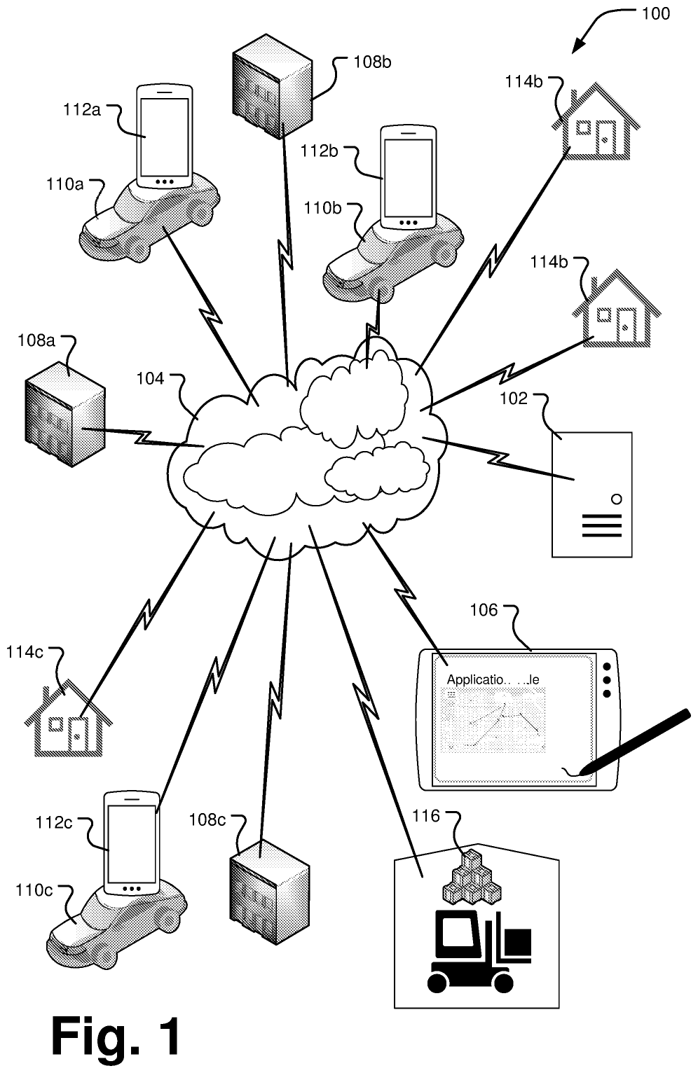

A real-time delivery operation management system, primarily for local or last mile delivery services to consumers, as disclosed herein may be implemented in a typical wide area telecommunication network leveraging internet cloud services, global positioning system (GPS) data, and mobile computing devices (e.g., smart phones). As shown in FIG. 1, the system 100 includes a central server 102 (which may be distributed via cloud services), which manages data and communications for the delivery platform. The server may house a database with the information used by the delivery platform, or the data may be held in distributed storage systems accessed over the internet. The server 102 is in communication with the other components of the system via a telecommunications connection with a wide area network 104, e.g., the Internet. All of the other components of the system to be described are similarly in telecommunications connection with the wide area network 104 as depicted.

The platform may include a courier management application with a graphical user interface (GUI) on a user computing device 106. The computing device may be a desktop computer, a laptop, a tablet computer, or even a smart phone. The interface may be accessed via typical devices such as a mouse and keypad. It may further be actuated by touch or a stylus on devices with touchscreen displays. In addition to the courier management application, a courier assignment and routing application is provided to all delivery couriers 110a/b/c participating in the delivery platform. Each of the delivery couriers 110a/b/c may access the platform via a personal computing device with GPOS location capability, typically a smart phone 112a/b/c with the ability to implement the courier assignment and routing application, provide telephone and text communication, and present street map with pickup and delivery locations.

Also on the network are businesses 108a/b/c that are selling goods to consumers (e.g., restaurants, grocery stores, and retail consumer goods stores) that want to offer delivery services to customers either over a platform that they control or through a third party manager operating a service on the platform. The businesses may themselves be fulfillment depots where purchased products are picked up for delivery. Alternatively, products sold by the businesses may be stored for pickup at one or more centralized warehouse depots. The businesses inventory and sales system may be tied in to the delivery system in order to easily populate orders and request delivery of the same. Alternatively, the businesses may directly enter data for each order into the system through an interface (e.g., an application on a computer, tablet, or smart phone, or through a web page interface) as they are received. The final parties to the platform are consumers 114a/b/c who purchase product from the businesses 108a/b/c and request delivery of the products. The businesses 108a/b/c may make the delivery arrangements for purchases or, in some instances, consumers may use an application interface to log their own delivery request via a third party manager on the platform and dispatch a courier to provide the delivery service.

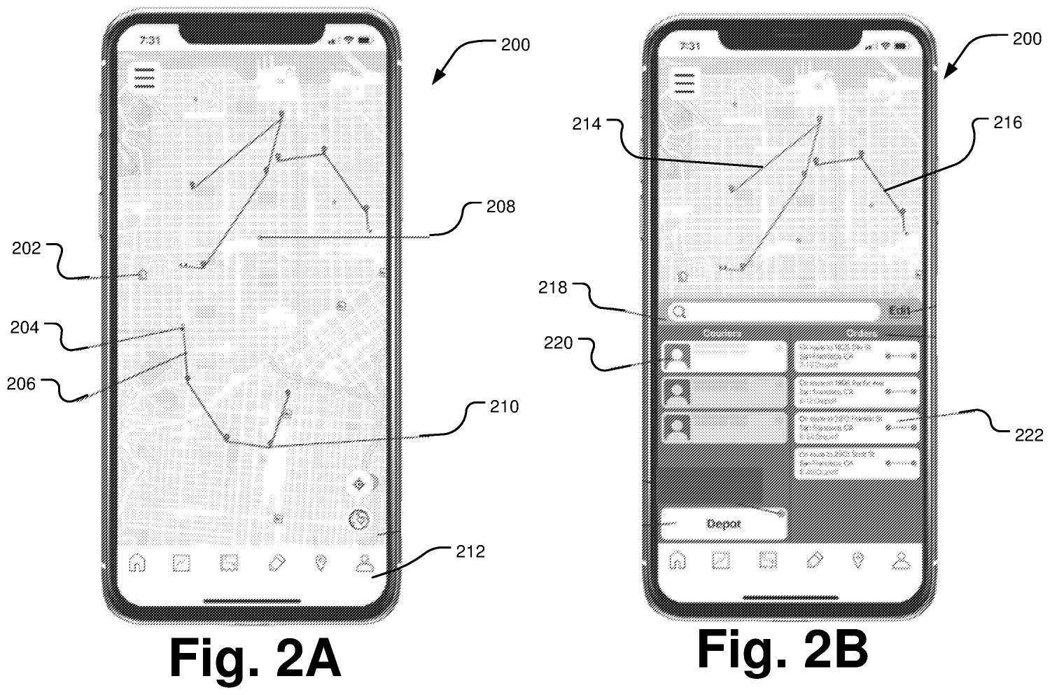

FIGS. 2A and 2B are schematic diagrams of mobile computing devices, e.g., smartphones 200 with GPS tracking capability implementing a courier assignment and routing application that is part of the platform. The GUIs of the smartphones 200 provide and interface for interacting with the application. In FIG. 2A, a number of interactive features are marked on the map display including a pickup depot 202, the position of the courier 204, positions of pickup or delivery locations 210, active, but unassigned order locations 208, and visible route paths 206 of couriers connecting depots, couriers, and order pickup locations, and delivery locations,. A control panel 212 may be provided on the bottom of the interface to access settings and manage assignments.

The smartphone 200 in FIG. 2B depicts an alternate courier interface with additional information and control. The interface may prove a map with courier routes 214, 216. The routes may be color coded to indicate the particular courier's route in one color and other courier's routes in another color. The lower half of the interface depicts a search bar function 218 that may allow the courier to quickly locate a pickup or delivery address or other information. Information about active couriers 220 and active orders 224 on the courier's route with delivery status may be provided as well. The GUI of the courier application may provide significant additional information and functionality not discussed herein.

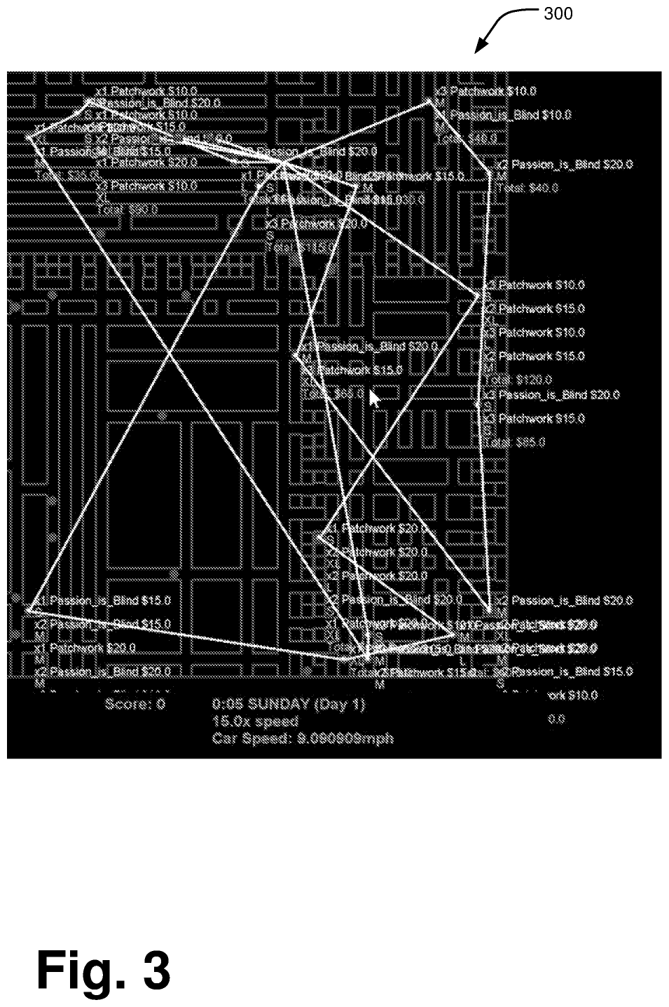

FIG. 3 is a screenshot of an example implementation of a management interface 300 for the courier and delivery management system. The management interface 300 works in tandem with an instant delivery route-making algorithm to visualize the route plan for hired or contracted couriers in a dynamic interface, allowing depot managers to view or alter the delivery plan in real time. This interface is built for commercial use for clients that wish to manually manage their own instant-delivery courier fleet with modern software infrastructure. Courier route assignment is performed automatically unless automation is disabled. The management interface communicates with the active couriers through the separate smartphone application interface. The management interface is utilized and accessed via a tablet computer, smartphone, or website interface.

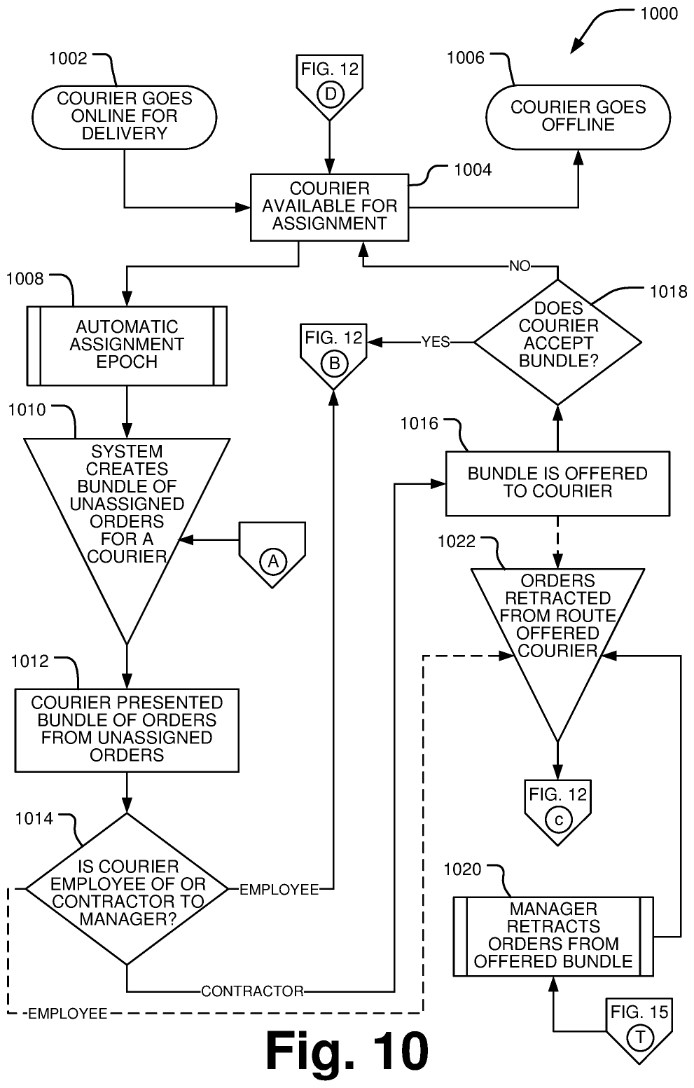

Displayed on the control panel is a GPS map interface. Pickup (i.e., depot) locations that pertain to the operator using the platform for delivery management are marked on the map. Employed couriers which are online, contracted couriers which are online, and active order locations are also all displayed. Identification information can be made visible as shown in FIG. 3 or turned off. Visible route paths connect the depot, couriers, and their relevant orders for both assigned and offered routes. Unique about this interface is that orders can be selected and dragged and dropped to reconfigure routes and assignment of orders to couriers. Orders can be drag-and-dropped on either existing routes, couriers, or depots to perform any of the operations described herein with respect to FIGS. 10-20. Following any operations all selected orders are unselected. If orders are dropped anywhere on the map not marked by a route, courier, or depot, the orders are unselected, and no action is performed.

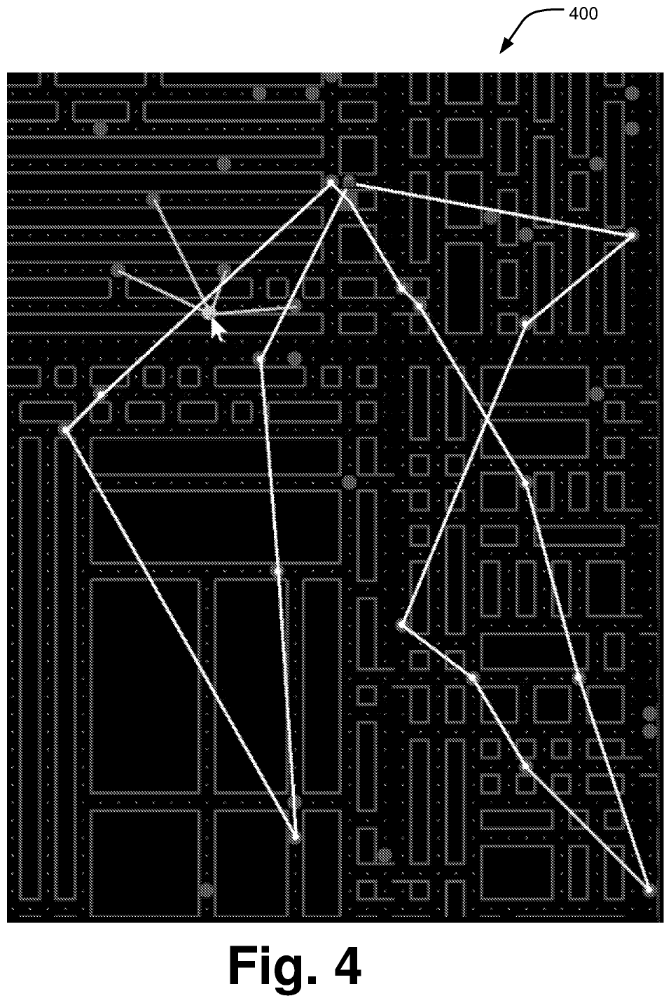

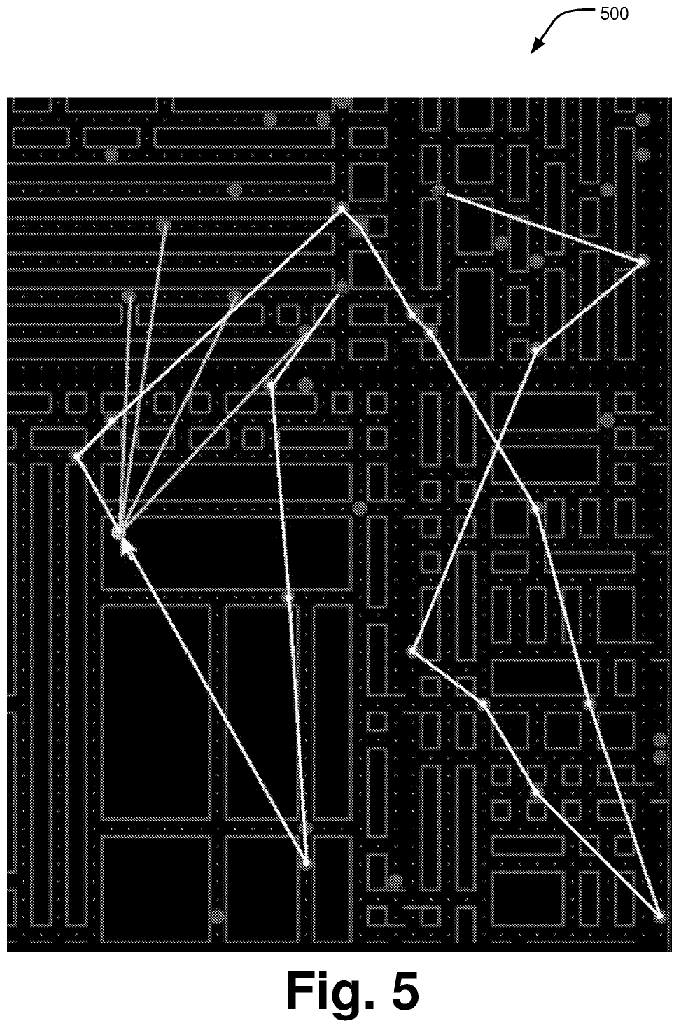

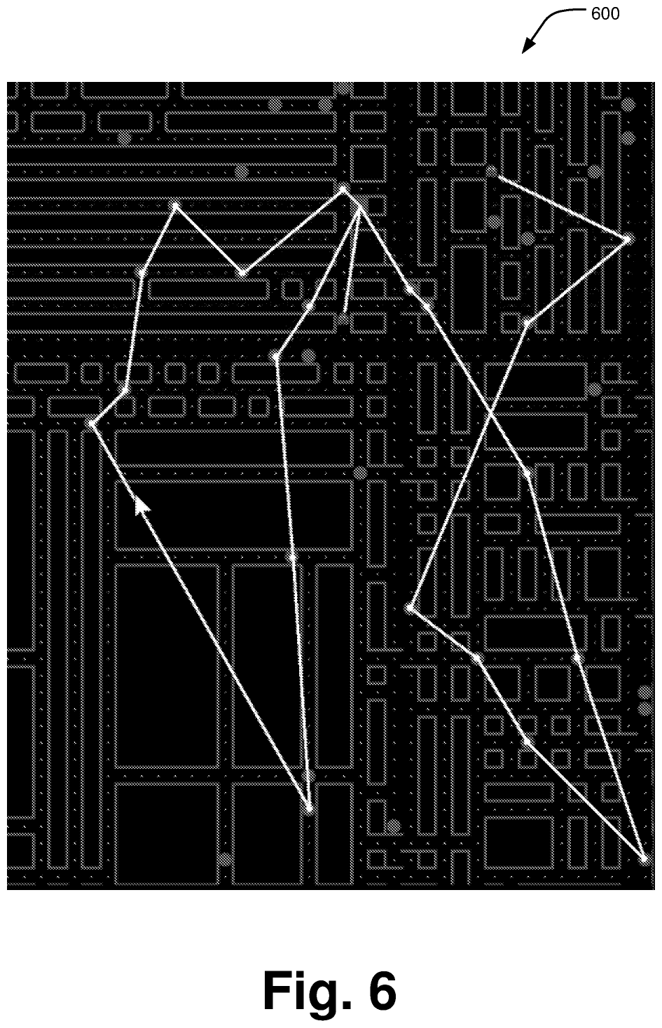

FIGS. 4-6 are a sequence of screenshots depicting one possible drag-and-drop feature provided by the management interface program. In FIG. 4 a courier route is shown (white lines) on the screenshot 400 of a delivery map. Pickup or delivery locations on the route are indicated by dots (blue) intersecting with the lines. Unassigned order and delivery locations are shown as dots (blue) that do not intersect with the courier route. A manger has selected four orders that have not been assigned (blue dots connected by green lines to a green connection dot). FIG. 5 depicts a second screen shot 500 in the sequence. In this image, the manager has placed the order collection dot (green) on a location on a courier route. FIG. 6 depicts a final screen shot 600 in the sequence. In this image, the previously unassigned orders (four blue dots) that were connected by the collection lines (green) are now part of the courier route (white line). A number of operations must occur to make this order addition to the courier route possible. These are described in detail herein with respect to FIGS. 10-20. However, to the courier manager, it is a very simple and intuitive process and no further management action is required. All reassignment and rerouting is done by the software platform.

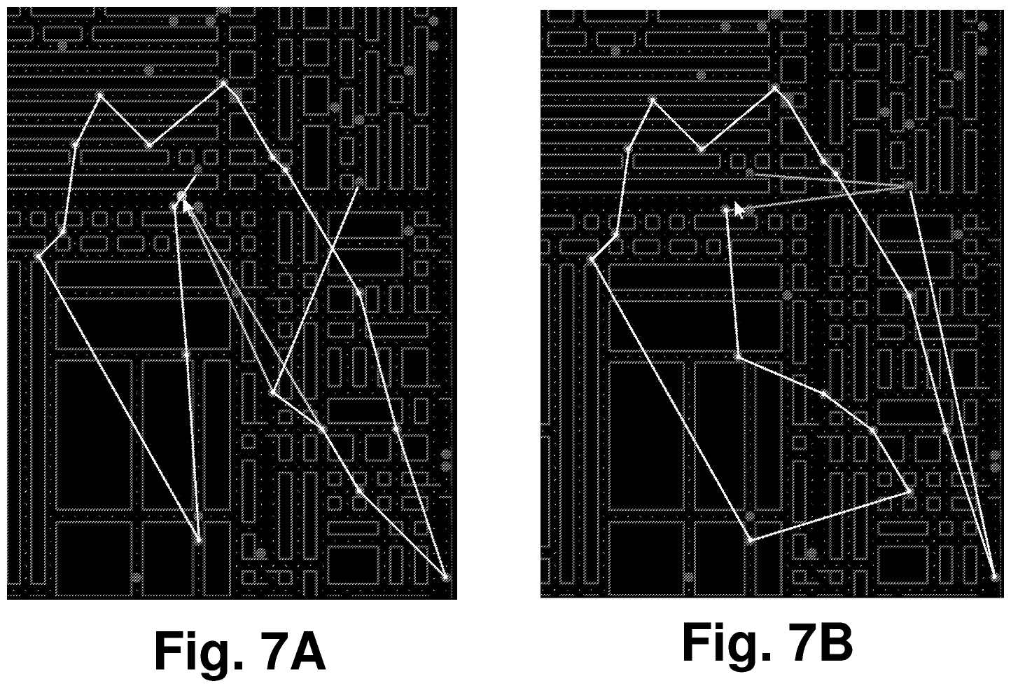

FIGS A-8B are a sequence of screenshots depicting another possible drag-and-drop feature provided by the management interface program. In FIG. 7A a courier route is shown (white lines) on the screenshot of a delivery map. Pickup or delivery locations on the route are indicated by dots (blue) intersecting with the lines. Unassigned order and delivery locations are shown as dots (blue) that do not intersect with the courier route. A manger has selected two orders that are already assigned to a courier (blue dots on the white route line connected by green lines to a green connection dot). The manager has placed the order collection dot (green) on a location on another courier route. In FIG. 7B, the route on the left side of the map has changed to include the two locations drawn over by the collection dot green). The route on the right side of the map no longer includes those delivery locations. However, the courier for the left side route needs the goods that the courier for the right side route has in their possession to deliver.

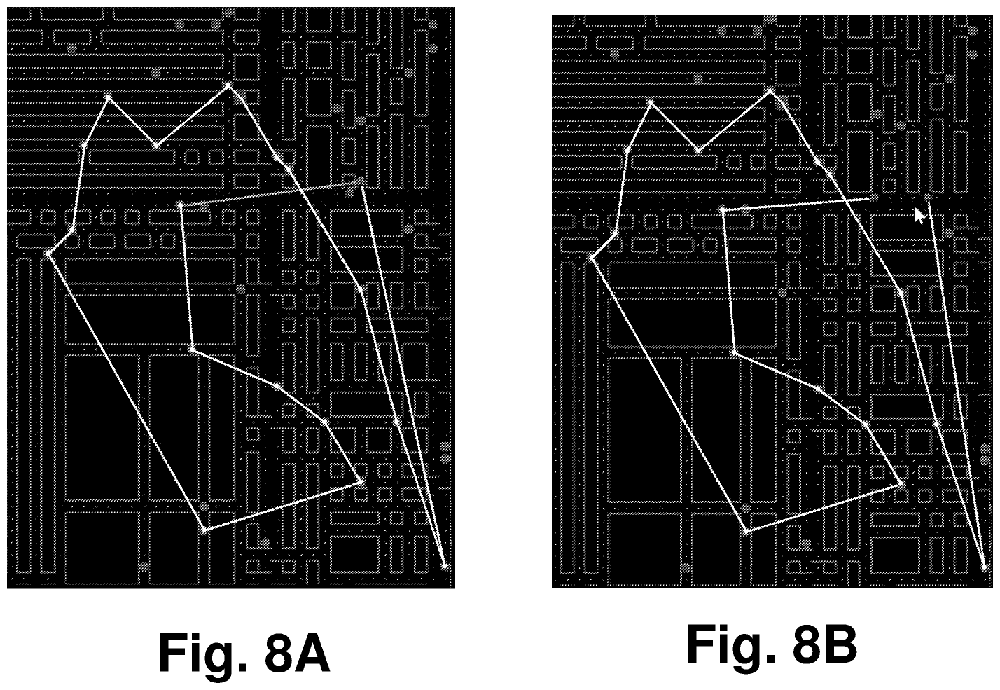

To effect a transfer of goods for delivery between two drivers, a transfer line (orange) appears as part of the left side courier route and includes a meeting point with the right side driver. As shown in FIG. 8A the left side courier has reached the right side courier to make the physical goods transfer. In FIG. 8B, the transfer line (orange) has disappeared and the couriers continue to follow their own separate routes, one with two more deliveries and one with two fewer. Again, a number of operations must occur to make this order addition to the courier route possible. These are described in detail herein with respect to FIGS. 10-20. However, to the courier manager, it is a very simple and intuitive process and no further management action is required. All reassignment and rerouting is done by the software platform.

The mapping and routing operations are performed by the integration of heuristic or artificial intelligence (AI) neural networks that are programmed to address and solve mapping problems such as delivery of goods. These types of intelligence programs are leveraged by the instant courier management platform to provide mapping and routing functionality. An exemplary neural network model for addressing this problem which may be used to implement the present system is the paper by Voccia et al., “The Same-Day Delivery Problem for Online Purchases; Tippie College of Business, University of Iowa, Iowa City, Iowa, USA 52242 (Oct. 4, 2015), available at https://www.researchgate.net/publication/282542065_The_Same-Day_Delivery_Problem_for_Online_Purchases.

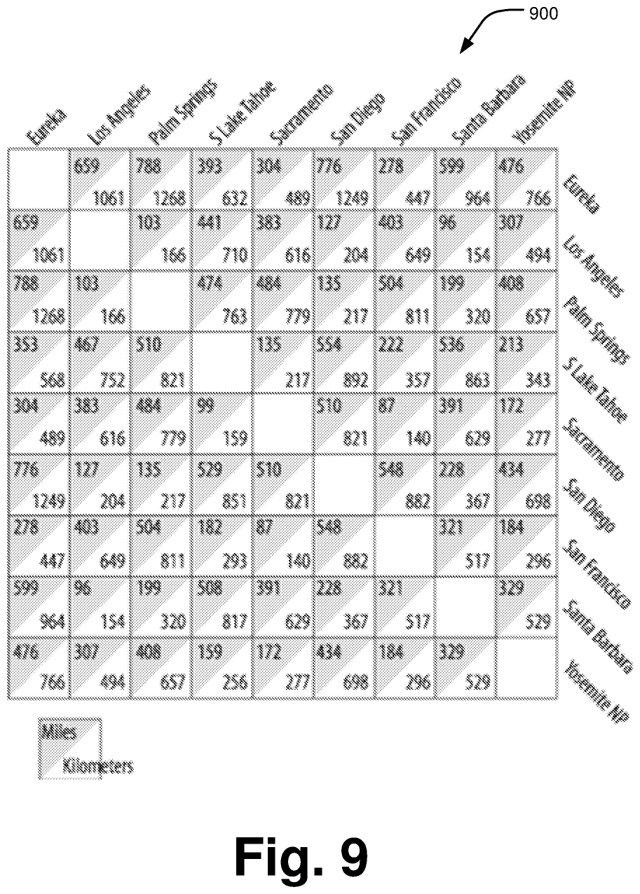

In a AI Neural Network route making model, the inputs are:
1. a network of orders connected with the time duration distances between them (a distance “multiplication table” format; see FIG. 9)—to build its general understanding of its options (ex):
2. The following commands (with the following data requirements):
   a. BUILD_NEW_ROUTE
      i. (input) All Unassigned Orders
      ii. (input) Number of subject couriers
      iii. (input) Target Vehicle Capacity (or list of . . . )
   b. INTEGRATE_ORDERS
      i. (input) A List of Subject Orders
      ii. (input) Pre-existing route (or a list of pre-existing routes)
   c. TRANSFER_ORDERS (produces transfer indexes)
      i. (input) A List of Subject Orders
      ii. (input) Pre-existing route (or a list of pre-existing routes)
      iii. (input) Target Vehicle Capacity (or list of . . . )
         The output is always in some form or another a list of orders in route drop-off order. (And optionally a list of indexes). The in between is just a hidden layer (a configuration of ‘neurons’ and ‘synapses’ with different adapted signals and no way to interpret how it works)

Alternatively, a heuristic route-making model may be employed. A route's ‘cost’ is computed by its total estimated time duration in minutes (factoring time spent at each stop, and whether or not they return to the depot post-delivery (employees do, contract workers don't)). For algorithms that take a target bundle size into account, a route's ‘penalty adjusted cost’ is calculated by original cost plus the difference between the route size and the target size multiplied by the avg. cost per order:

cost+((# of orders in route−target route size)*(cost/# of orders in route))

This simulates each order beyond the target size carrying double the time-weight of a normal average order.

FIGS. 10-20 together present an integrated, extended flow diagram of a computer system implementation of mechanics for real-time management of a delivery operation, allowing a manager of the system to easily assign, transfer, and reroute items for delivery among any number of active couriers. The system allows the manager to visualize all couriers and their routes of on a map interface, view all delivery locations for orders on the map, and view all pickup depots (e.g., businesses with items ordered for delivery). The manager can select orders for assignment using a computer mouse or similar interface tool, drag and drop the orders from the delivery locations onto a courier or onto the courier's route, thereby assigning the orders to the courier for pickup from one or more depots and then delivery to customers. The manager can further use the GUI interface to drag and drop new, unassigned orders and add them to an already established route of a courier, transfer orders from one courier to another by dragging orders from the route of one courier to another, and wholly remove orders from the route of a courier for later assignment. The system also provides accommodation for using both employee couriers and independent contractors with different treatment of each at appropriate times.

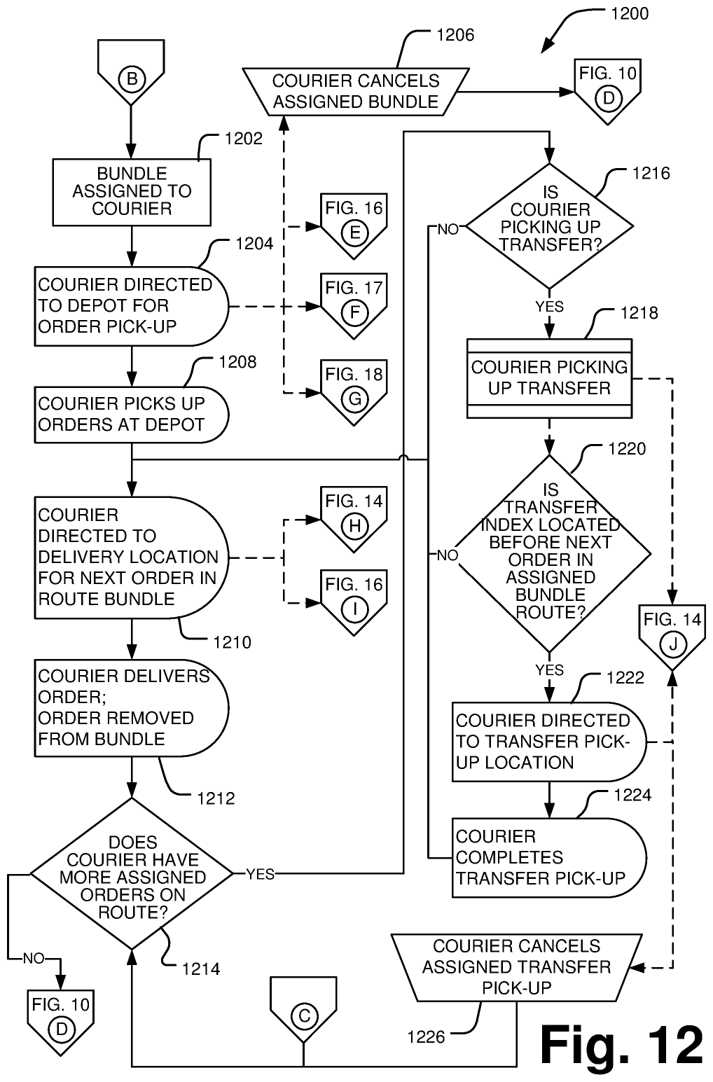

The underlying system functionality begins from the courier perspective in the processes (1000) of FIG. 10 when the courier indicates on the application interface on the courier's mobile device that the courier is now online (operation 1002) and actively accepting delivery assignments (operation 1004). In addition, the courier's status may change to actively accepting assignments in operation 1004 once the courier has completed a prior assignment as described later in with FIG. 12 (input D). Notably, if the courier switches status on the couriers mobile device to “offline,” the courier is no longer available to accept assignments and will not appear on the map interface nor be considered in the further operations of the system.

When a courier goes online or a courier becomes available for delivery assignment, the delivery operation management system will first utilize an automatic assignment epoch algorithm (subroutine 1008) to sort all unassigned orders into time-efficient employee courier bundles (operation 1010). The automatic assignment epoch algorithm may make assignment bundles based upon criteria such as geographic proximity of delivery locations, traffic flow and patterns, types/sizes/weights of orders/packages, type of vehicle driven by the courier vis-a-vis the type of order, etc. Table 1 below is an example of pseudo code for an implementation of a manual assignment epoch (subroutine 1304).

```
TABLE 1
1.0 Automatic Assignment Epoch (automatically runs iteratively whenever new
    courier becomes available or when order appears in order database):
    1.1. Determine how many employee couriers online & available (prioritized)
    1.2. Determine how many contract couriers are online & available (will avoid
        these)
    1.3. First for employees, then contractor (multiple times for each group for total #
        of vehicle types)
      1.3.1. For every new order
      1.3.2. Determine target route size
        1.3.2.1. Total # unassigned orders / # couriers available; OR
        1.3.2.2. Total # unassigned orders / maximum capacity per courier
        1.3.2.3. Whichever one makes more routes is the one picked
  [Note: For contractors, the target route/bundle size is ALWAYS the courier max
  capacity (always 3bii). In contrast, employees may alternatively be assigned via
  3bi to minimize time spent. This is to minimize the number of contract workers
  utilized.]
    1.4. Order data received
      1.4.1. Pickup location
      1.4.2. Drop-off location
      1.4.3. Delivery start -time
      1.4.4. Delivery deadline
      1.4.5. Weight capacity/volume
    1.5. Mix & match routes (Goal is to place orders into efficient routes. Looks for
        efficient paths)
      1.5.1. Equation for calculating route cost; compare to cost or other route
      1.5.2. Move orders between routes to minimize route costs
    1.6. Routing algorithm output:
      1.6.1. Groups of orders in bundles and relate route
      1.6.2. Determines and compares urgency score of bundles
        1.6.2.1. Rank I - orders with drop-off time impossible to achieve
        1.6.2.2. Rank II - orders not in I that cannot be picked up at ready time
        1.6.2.3. Rank III - orders not in group Deadline
      1.6.3. Most urgent routes assigned first and prioritized
        1.6.3.1. Determine weight of assigning a certain courier to a certain
              route
        1.6.3.2. Varies based on their availability relative to the orders, and
            distance from the pickup
        1.6.3.3. Courier with highest score assigned route
[Example: //Pairing route ii to courier i
    score = (routes.get(ii).size( )/(latestOrderDropOffTime -
    couriers.get(i).getEstimatedAvailabilityTime( ))) -
    (firstOrderSubject.getPickupTime( ) - latestOrderReadyTime)]
[Note:
    Number of orders in route ii divided by (the latest order drop off time minus the
    time the courier next becomes available)
    minus
    pickup time of the route minus the latest order ready time, (should be positive)
    (calculates the delay penalty)
Test this with every order and courier combo.]
    1.6.4. Prioritize routes assigned to employee couriers
      1.6.4.1. Contract worker must accept or reject; order not set until
            accepted
      1.6.4.2. Consider vehicle type for job type-runs through each vehicle
            type for both employee pool and contract worker pool
      1.6.4.2.1. Semi, trailer, pickup, van, car, motorbike, bicycle,
              pedestrian
      1.6.4.2.2. Each routine contains a different courier vehicle capacity
              based on the vehicle type
      1.6.4.2.3. Merchant can optionally prioritize vehicle types
      1.6.4.2.4. Can also outsource delivery to other delivery services
[Example: & run the 1-6 routine 16 times like so:
    EMPLOYEE
    1. Semi, 2. trailer, 3. pickup, 4. van, 5. car, 6. motorbike, 7. bicycle, 8.
    pedestrian
    CONTRACT WORKER
    9. Semi, 10. trailer, 11. pickup, 12. van, 13. car, 14. motorbike, 15. bicycle, 16.
    pedestrian
    (Unless priority order is reorganized by the Merchant)]
[Note: For all automatic assignments, things like going over vehicle capacity &
assigning inefficient orders will be avoided. However manual assignments will
override this.
    Example 1: algorithm will not ‘stop' a Merchant from assigning 50 orders to
    one courier when the max capacity is set to 6.
    Example 2: algorithm will not ‘stop' a Merchant from scrambling the routes to
    make them less efficient. For all it knows, the Merchant knows their way
    around town better.]
1.7. Courier App
    1.7.1. Route delivery locations identified and dropped as pins on map in order
        and map program plots route.
    1.7.2. Real-time communication about transfers
    1.7.3. For contract worker, every new order requires consent, route
        provisional.
```

Since contract couriers may potentially be working for multiple businesses concurrently, it is not guaranteed that they'll be stationed at any particular depot awaiting delivery (i.e., they may be roaming freely). Thus, contract couriers are more likely to be many different distances away from a particular merchant depot at any given time. This is likely in contrast to employee couriers who may work for only one business at a time and are always directed back to a home depot post-delivery where they await another assignment of an order bundle. Choosing the right contract courier for the route matters in terms of cost and timely delivery of an order. Furthermore, it is possible that a merchant could have hundreds of contracted couriers at any given time, with each contractor choosing whether or not to accept a delivery assignment and also choosing the time periods during which they work. This is again in contrast with employee couriers who the merchant directly controls and schedules when they work. Therefore, an additional weighting algorithm may be utilized to weigh the viability of assigning contractor couriers and to minimize costs of contractor assignments if made. Such an algorithm, which may be run after the routes are created, may determine the weight, and thereby the relative benefit, of assigning a certain courier to a certain route, which varies based on their availability relative to the orders, and distance from the pick up location.

Returning to FIG. 10, the system then selects a courier and presents the bundle of orders thus created to the courier for delivery (operation 1012). Before, confirming the assignment, the system first checks the status of the courier to determine if the courier is an employee of the business managing the deliveries (operation 1014). If the courier is an employee, the bundle assignment is automatic and the process continues as described later in FIG. 12 (input B). In some implementations, it may be desirable that employee couriers are always preferred. If the system is set to such a default, employee couriers with availability will always be automatically assigned delivery bundles.

If no employee couriers are available and there are still unassigned orders, the remainder of the orders may then be removed from the employee bundle pool and re-sorted into time efficient contract courier bundles and a similar automatic assignment algorithm will be used to determine which available contract couriers the bundles shall be offered to. The automatic assignment algorithm for contractor assignments may be the same algorithm as used for the employee assignments, but may have different preference settings applicable to contractors that may affect assignment weighting (e.g., contractors with higher performance ratings receive preference). As indicated in FIG. 10, if it is determined that the bundle assignment is made to a contractor (operation 1014), the bundle is offered to the contractor for delivery (operation 1016). Unlike an employee, the delivery bundles may not automatically be assigned to the contractor. The contractor has to accept the terms of the offer (e.g., the type of delivery, the location, and the amount of payment). If the contractor accepts the offer (operation 1018), the process continues as described later in FIG. 12 (input B). If the contract courier declines the offered delivery bundle, the delivery assignments are returned to the pool and the contract courier's status returns to available for assignment (1004). If no employee or contract couriers are available, the system continues to collect delivery assignments until a new courier comes online or completes a prior assignment (unless a manager intercedes to make manual assignments as further discussed below).

Note that it is possible for a manager of the system to intercede and actually remove orders from a bundle (operation 1020) before acceptance of the assignment by a contract courier or completion of the automatic assignment to an employee courier as well as retract orders from the assigned route of a contract worker. If a manager selects assigned orders on a plotted route and selects a retraction command through the interface (operation 1020), the order assignments will be instantly rescinded from their currently offered route and converted back into unassigned orders (operation 1022). (This possibility is indicated in FIG. 10 by the dotted line between operation 1016 and operation 1020.) In such an event, the process will transfer to FIG. 12 (input C) for an initial determination of the assigned order status for a courier who has less than all orders rescinded rather than immediately sending the courier back to the queue awaiting a new assignment (operation 1004).

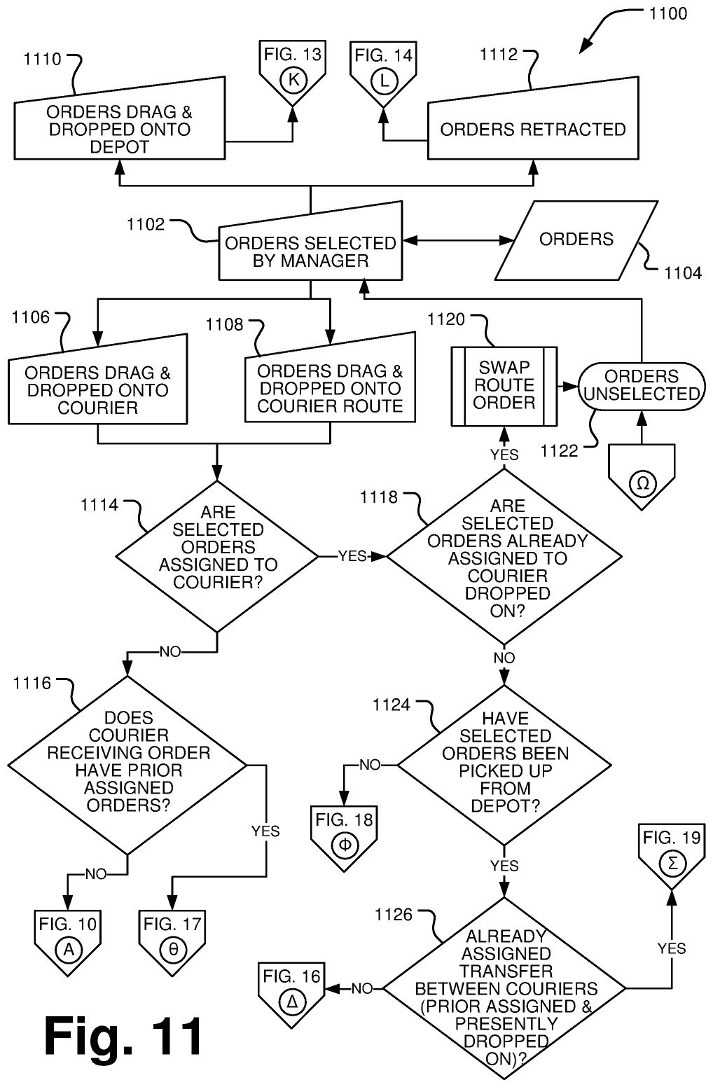

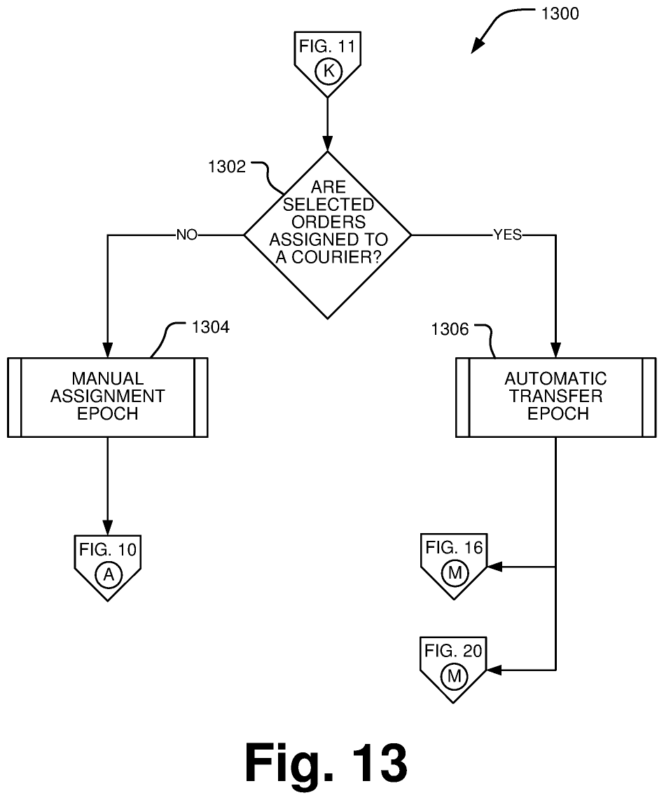

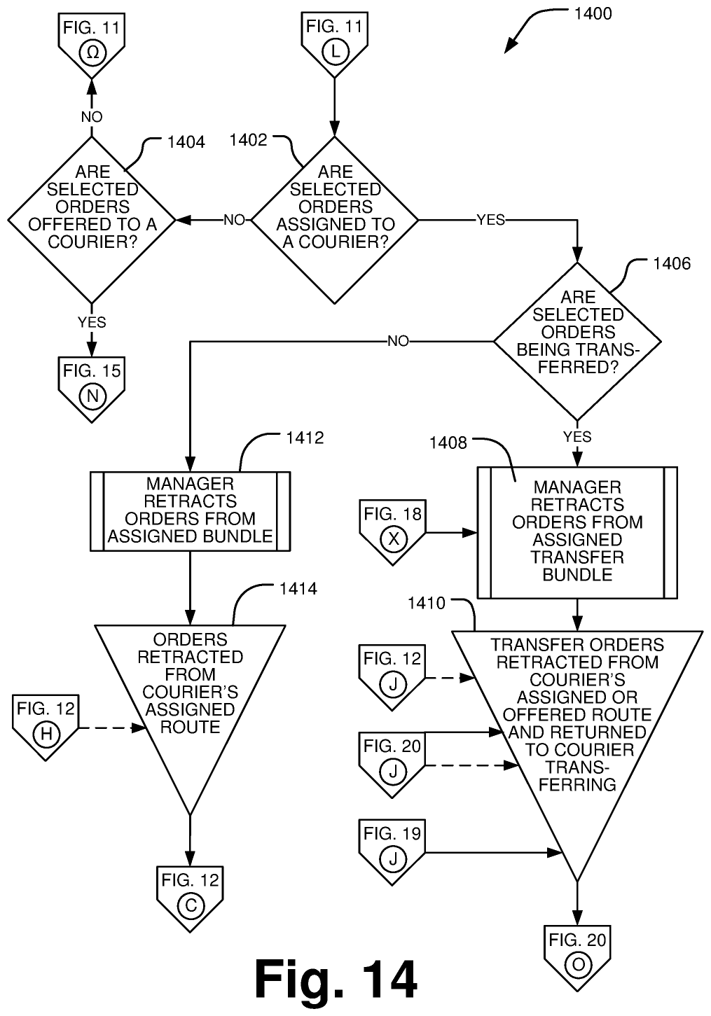

An overview of processes (1100) for management of the system and manual assignment of orders to couriers is presented in FIG. 11. As indicated, both unassigned and previously assigned orders may be manually selected by a system manager (operation 1102) on the GUI map interface. The orders, represented as geographic delivery locations on the map interface, are populated from a constantly updated dataset of orders (1104) in a database. The system manager has four primary options for management of order assignments to couriers, all of which can be implemented using selection and drag and drop functionality in the GUI interface. A first option is to select and drag and drop orders (either unassigned or previously assigned) onto a courier for assignment to that courier (input action 1106). A second option is to select and drag and drop orders (either unassigned or previously assigned) onto a courier route (input action 1108). These first two options will be described in greater detail below with respect to FIG. 11. A third option for manager selection is to select and drag and drop orders (either unassigned or previously assigned) onto a depot (input action 1110). This command can only be processed if assigned orders have not yet been picked up at the depot by the assigned courier. In response to this management option, an algorithm will process an automatic reallocation and bundle creation of new delivery bundles for allocation to couriers. This option is described in greater detail beginning on FIG. 13 (input K) as indicated. A fourth option for courier management is to select previously assigned orders and retract them from their present courier assignment (input action 1112). If this command is selected by the manager, the process follows the steps further outlined in FIG. 14 (input L) herein, which defines both what happens with the courier and what happens with the retracted orders.

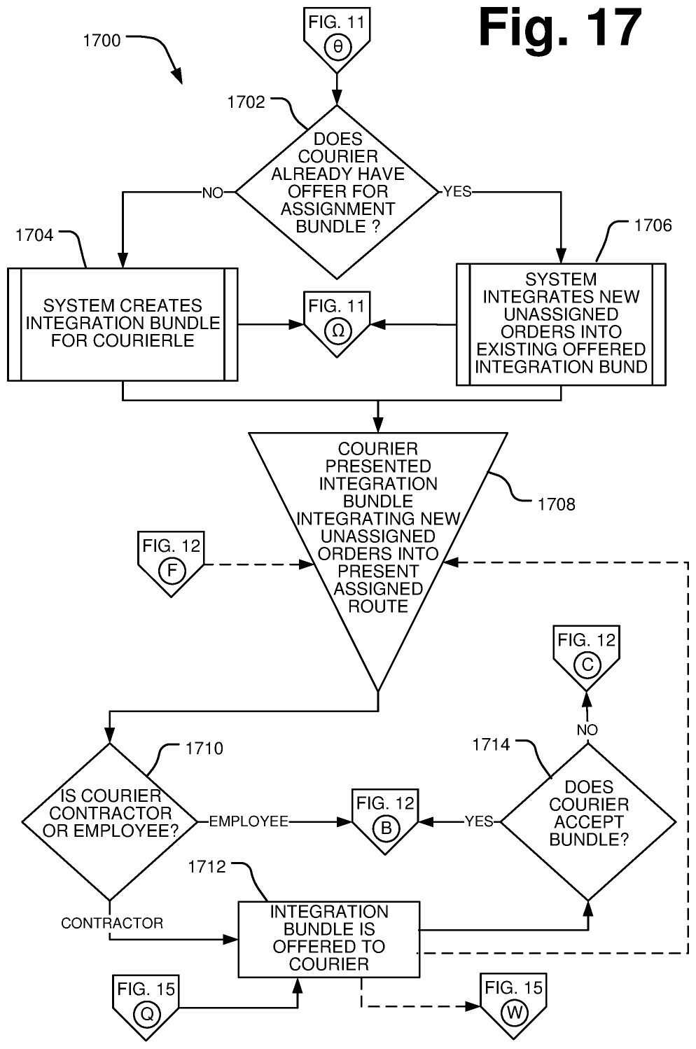

Returning to FIG. 11 and considering either the first option of manually assigning orders to a courier (input action 1106) or the second option of manually placing orders at a location on a route already assigned to a courier (input action 1108), the process 1100 proceeds for both and differentiates further action based upon the type of management action as follows. Once manual order assignment input (input action 1106 or 1108) is received, a determination is made whether the selected orders are already assigned to any courier (operation 1114). If the answer is no, the process 1100 continues to a further determination of whether courier receiving the order has other previously assigned orders (operation 1116). If the courier does not have any other assigned orders beyond the ones manually assigned in input action 1106 or 1108, the process will return to FIG. 10 (input A) some that the system can make a bundle of those orders for the courier and identify a delivery route for assignment. If the courier does have other order delivery assignments already, the process will proceed to the steps in FIG. 17 (input θ) to integrate the reassigned orders from the manager with the courier's previously assigned orders.

Returning to operation 1114, if the orders manually selected are already assigned to a courier, further determinations are made. First, the process considers whether the orders selected by the manager are already assigned to the courier or courier route that the orders were dropped on (operation 1118). Such a reassignment might be appropriate if the manager wants to change the delivery order of the orders assigned to the courier. If the orders are dropped onto the same courier or route in operation 1118, the process continues to attempt to change or swap the delivery order (subroutine 1120). For example, if selected orders (e.g., orders C and D) are assigned or offered and the manager drag-and-drops them directly onto to another portion of the same courier's route (i.e., the line connecting orders A and B), orders C and D are shifted to be delivered between orders A and B. The system may recalculate the best route in consideration of the changed delivery order and update the route map for both the courier and the manager. Alternatively, if the orders were dropped on the courier icon itself rather than a different part of the route, or the selected orders were dropped on the same portion of the route, the process will view this as a user error, the orders are unselected for action (operation 1122) and are no longer represented as selected in the manager GUI and the prior order in which the selected orders are to be delivered is maintained. This process 1100 then terminates and returns to monitor for further selection activity by the manager (input action 1102).

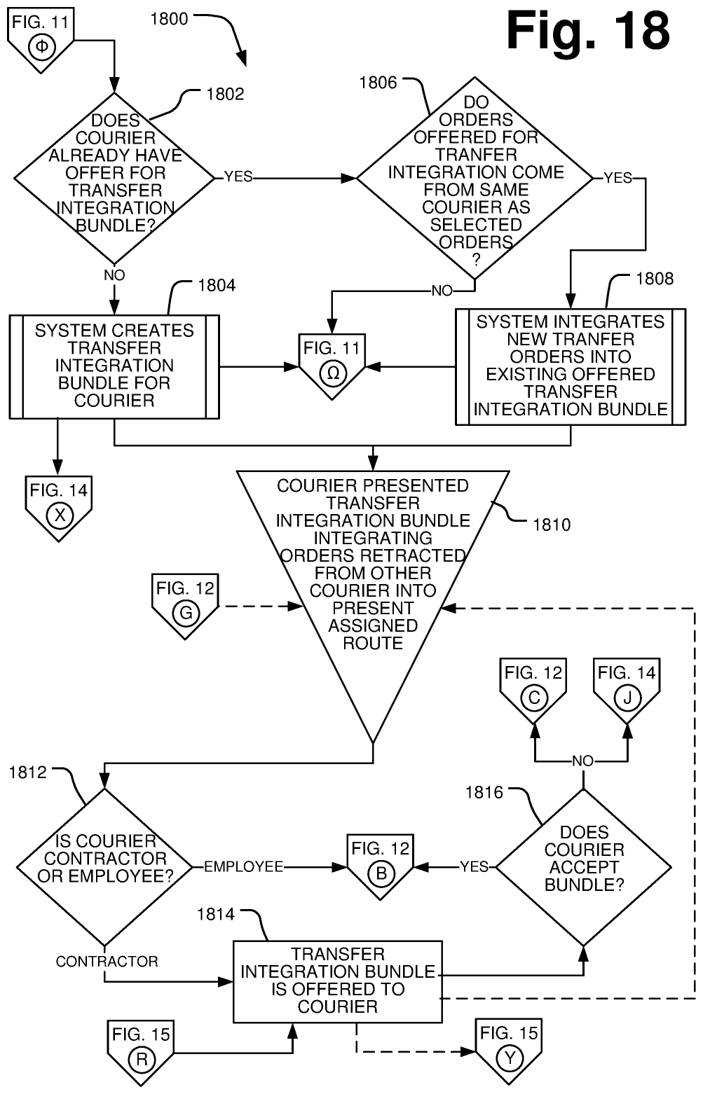

Returning to operation 1118, if the orders are instead dropped on a different courier or courier route than originally assigned, the process proceeds to further determination of whether the orders have already been picked-op by the courier from the depot (operation 1124). If not, the process transfers to the steps in FIG. 18 (input Φ) to determine whether the courier has been previously offered or assigned additional orders or bundles in another action in order to coordinate and integrate the order transfers. For example, the manager may have selected a first order from the route of a first carrier and a second order from the route of a second carrier in separate actions and allocated both to a third carrier. The steps in FIG. 18 are designed to address order integration in this and similar circumstances.

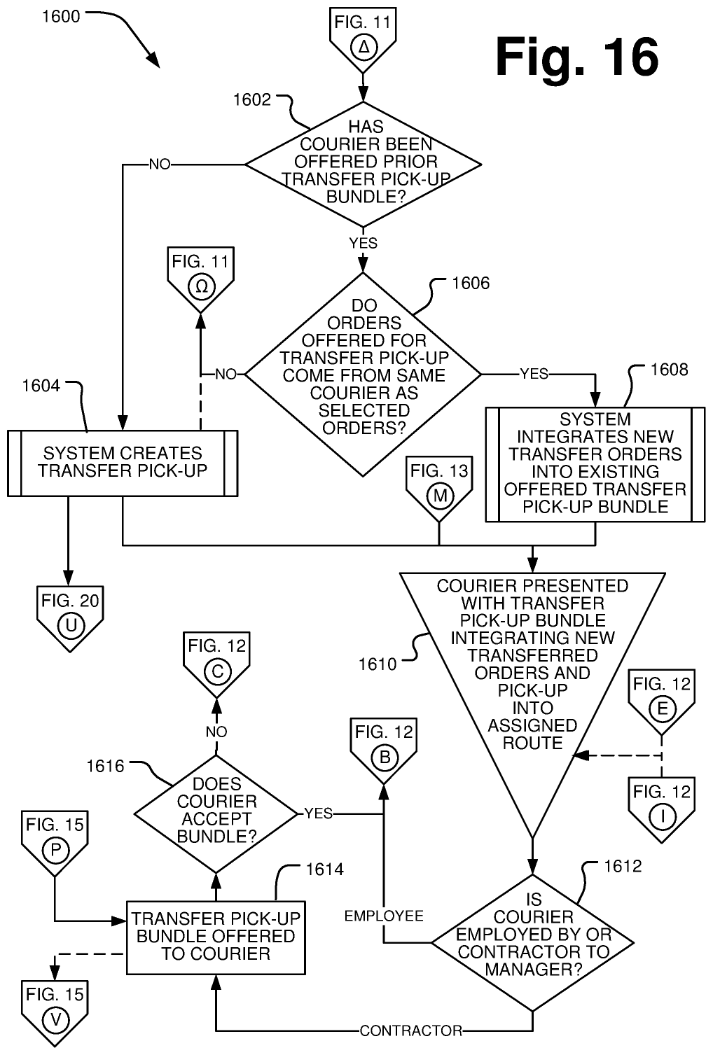

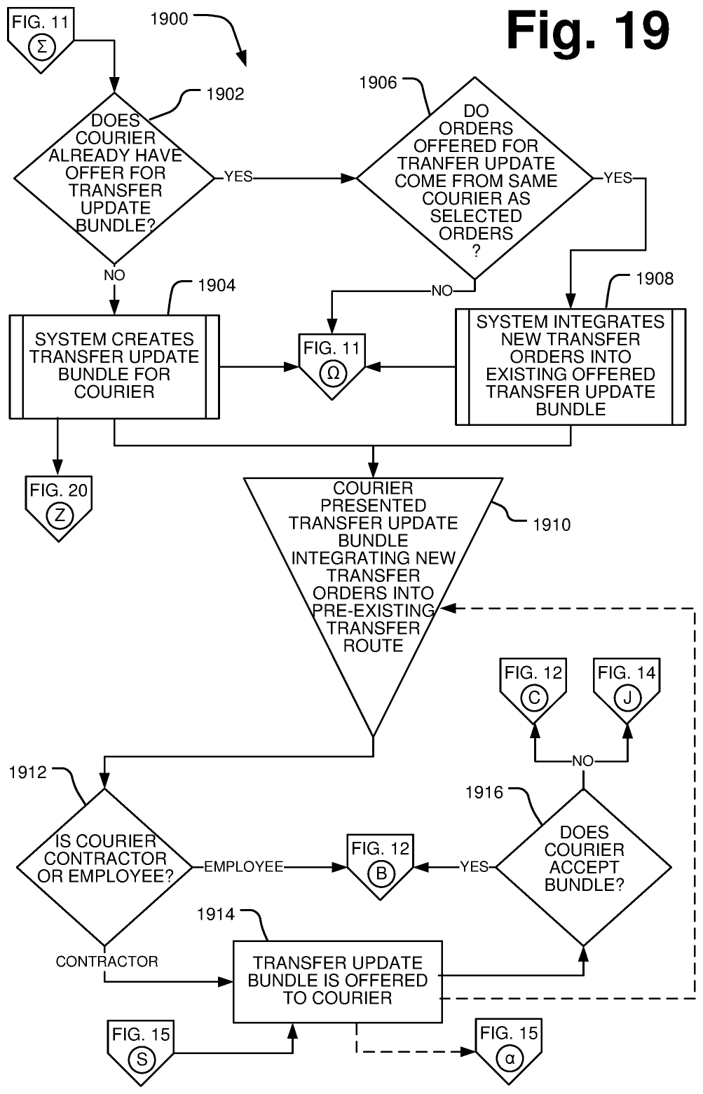

Returning to operation 1124, if the courier has already picked up the orders from the depot, the process 1100 makes a further determination of whether there has been a prior transfer of assignment of the orders between couriers (operation 1126). For example, the manager may have previously transferred an order from courier A to courier B and now the manager is attempting to transfer the order from courier B to courier C before carrier B makes a delivery. However, since the order has already been picked up from the depot by either courier A or courier B, the process needs to consider which courier has the order and how best to get the order to newly assigned courier C. This could involve a direct transfer between whoever has the order (courier A or courier B) to courier C at a meeting point, an indirect transfer (i.e., from courier A to courier B and then to courier C), or a drop off of the order at a depot by courier A or courier B to be picked up by courier C. If there was not a prior transfer between other carriers, then the process will move to the steps in FIG. 16 (input Δ) for further processing to integrate the newly transferred orders with the courier's other orders. Alternatively, if there was a prior transfer between other carriers (e.g., between courier A and courier B before assignment to courier C), then the process will move to the steps in FIG. 19 (input Σ) to determine how to most efficiently handle the transfer of the product order between carriers.

FIG. 12 represents the primary flow of courier actions once a courier is assigned or accepts an order bundle. Alternative operations may occur at many points during the flow, generally due to a manager implementing a transfer operation as described in FIG. 11. In such case the delivery steps may be interrupted and follow alternate paths to other operations of the system as suggested by the dashed lines in the diagram of FIG. 12 as well as in other related figures. The process of FIG. 12 typically starts at input B with a bundle being assigned to a courier (operation 1202). (Input B may be the output from many other discrete processes in the system as described herein.) If the bundle assigned is the initial assign for a courier or if the courier has completed a prior assignment, the courier will first need to pick up product ordered for delivery from a depot. The process may first identify the depot location on the courier application and provide map directions to the depot to the courier (operation 1204). During the period that the courier is in route to the depot is an opportunity for assignment changes and transfers to be made by a manager, i.e., before the orders are picked up at depot. Thus, the process flow indicates that assignment changes are possible and that the operations depicted in FIG. 16 (at input E), FIG. 17 (at input F), and FIG. 18 (at input G) may alternatively be implemented for the courier. In addition, if for some reason the courier cancels acceptance of the assigned bundle (operation 1206) before picking up the order bundle at the depot (e.g., due to personal need, delay, etc.), the process will return the courier to the queue in FIG. 10 (input D) to await assignment of a new bundle.

If the courier reaches the depot, the courier will pick up the orders in the assigned bundle (operation 1208) and will then be directed via the map interface on the courier mobile application to the first delivery location on the route plotted for delivery of the orders in the bundle (operation 1210). Note that this is another period during which actions of a manager transferring orders between couriers may occur. If such a transfer requirement is implemented by a manager, the process directing the courier may shift as indicated to FIG. 14 (input H) to determine whether to retract orders from the courier or to FIG. 16 (input I) to determine how to implement a transfer order. Once the courier delivers an order and confirms delivery on the mobile courier application, the order is removed from the courier's order bundle (operation 1212). The system then determines whether the courier has more orders to deliver in a bundle (operation 1214). If the courier has no additional orders assigned and the delivery route is complete, the process 1200 switches the status of the courier to available for a new assignment as depicted in FIG. 10 (input D).

If the courier still has assigned orders to deliver, the process 1200 next determines whether the courier needs to pick up an order assigned in a transfer (operation 1216). If the courier does not need to pick up a transfer order from another courier, the courier is free to continue to the next delivery location (operation 1210). If the courier has been assigned a transfer and needs to pick it up, the process changes the status of the courier to “in-transit” for transfer order pickup and alters the courier's map to identify the transfer location (operation 1218). As indicated in the process flow of FIG. 12, this is another point at which the courier is subject to redirection by the manager which would transfer the process to FIG. 14 (input J). The process then determines whether the transfer pickup location is before or after the next delivery location in the bundle (operation 1220). If the transfer location is after the next delivery location for the courier, the courier is directed to the next order delivery location (operation 1210) before picking up the transfer order. If the transfer location is before the next delivery location, the courier is directed to first travel to the transfer location to pick up the transfer order (operation 1222).

As indicated, this is another opportunity for the process to implement retraction or transfer of orders by a system manager, in which case the courier direction is transferred to the process of FIG. 14 (input J) for further immediate consideration and direction. Alternatively, if the courier cancels the assigned transfer order as indicated in input action 1226, the courier direction is removed from the transfer sequence and redirected to determine whether the courier has any more originally assigned orders to deliver (operation 1214). If the courier is not redirected and does not cancel a transfer order, the courier proceeds to complete pickup of the transfer order at the transfer pickup location (operation 1224). Once it the courier confirms receipt of the transfer order, the courier is directed to proceed to the next delivery location (operation 1210).

FIG. 13 depicts a process 1300 that is the start of a more detailed discussion of assignment of orders to couriers by a system manager when the manager moves either previously assigned orders or unassigned orders to a depot for distribution as previously discussed in FIG. 11 (from output K). In FIG. 13 (input K), the process 1300 initially determines whether orders selected by a system manager had been previously assigned to a courier. If not, the selected orders are assigned pursuant to a manual assignment epoch (subroutine 1304). According to the manual assignment epoch (subroutine 1304), when unassigned and unoffered orders are selected and dragged-and-dropped directly onto a depot on the map, the depot may first utilize an algorithm to sort those orders and into time-efficient employee bundles.

If no employee couriers are available and there are still unassigned selected orders, the remainder of the orders will be will then be removed from their employee bundles and re-sorted into time efficient contract courier bundles and a separate algorithm may be used to determine which available contract courier the bundles shall be offered to. If no contract couriers are available, and there are still orders in selection, and an optional integration setting is turned on, the program will then gather employees with already assigned routes, yet who have yet to pick up their orders at the depot, and it will integrate them into those assigned routes with the goal minimizing the increase in route cost for each employee courier within this category. If no employee couriers fit this category, the same actions will be performed with assigned contract couriers in their pre-pickup state only the integration orders will be offered, not assigned. If no contract couriers fit this category, or the integration setting is deactivated, no actions will be performed. Table 2 below is an example of pseudo code for an implementation of a manual assignment epoch (subroutine 1304).

```
TABLE 2
2.0 Manual Assignment Epoch:
    2.1. Locate all available employees and assign bundles to them (to max capacity).
      2.1.1. Determines target route size
          2.1.1.1. Total # subject orders / # couriers available; OR
          2.1.1.2.  Total # subject orders / maximum capacity per courier
          2.1.1.3. Whichever one makes more routes is the one picked
      2.1.2. Create routes (create empty lists: # of routes = Total # subject orders /
          target route size)
      2.1.3. (Run a mini-algorithm to get things started) For each route:
          2.1.3.1. Go through every subject order, see which one starts the route
              off with the smallest route cost, add that order to the route, remove it
              from the subject order pool.
      2.1.4. For each order in the subject pool:
        2.1.4.1. Try adding this order to every possible position of every route,
        2.1.4.2. Remove choices where:
        2.1.4.2.1. The order increases the route size past the target route
              size AND increases average cost per order.
        2.1.4.2.2. The order increases the route size past 4/3rds
              (133.33%) of the target route size.
        2.1.4.3.  See which available position increases the route cost the least
            (using the penalty adjusted cost).
        2.1.4.4. Add the order to this position of this route.
      2.1.5. (Remove-reinsertion optimization algorithm) For every order in every
          route:
        2.1.5.1. Remove order from its route
        2.1.5.2. Rerun 2.1.4. with order (reinsert it into the available
            route/position with the lowest increase in route cost).
      2.1.6. Rank all routes by urgency (group each order 1-3 and compare group
          average of routes)
        2.1.6.1. Rank I- orders with drop-off time impossible to achieve
        2.1.6.2. Rank II - orders not in I that cannot be picked up at ready time
        2.1.6.3. Rank III - orders not in group Deadline
      2.1.7. Assign most urgent routes, discard the rest (to spill over into the next
        pool)
  [Note: An AI routing module can be substituted for 2.2.2-2.1.6 with the command
  “BUILD_NEW_ROUTE” by plugging in the appropriate fields.]
  2.2. Locate all employees that haven’t yet picked up their orders and assign
      integration bundles to them (to max capacity).
  [Note: This command comes with a set of pre-existing routes, the routes that were
  previously assigned to the subject couriers.]
    2.2.1. Target route size is automatically set to be = remaining subject orders /
        vehicle capacity.
    2.2.2. For each order in the subject pool.
      2.2.2.1. Try adding this order to every possible position of every route,
      2.2.2.2. Remove choices where:
        2.2.2.2.1. The order increases the route size past the target route
              size AND increases avg. cost per order.
        2.2.2.2.2. The order increases the route size past 4/3rds
              (133.33%) of the target route size.
        2.2.2.3. See which available position increases the route cost the least
            (using the penalty adjusted cost).
        2.2.2.4. Add the order to this position of this route.
  [Note: No remove-reinsertion needed; routes are already assigned.)
  [Note: An AI routing module can be substituted for 2.2.2 with the command
  ″INTEGRATE_ORDERS″ by plugging in the appropriate fields.)
  2.3. Locate contract workers that haven’t yet picked up their orders and offer
      integration bundles to them (to max capacity).
  [Note: This command comes with a set of pre-existing routes, the routes that were
  previously assigned to the subject couriers (OR their offered integration route with
  priority if they have one to factor for previously offered orders. In this case, the
  integration process is just 2.5 instead of 2.4).]
    2.3.1. Target route size is automatically set to be = remaining subject orders /
        vehicle capacity.
    2.3.2. For each order in the subject pool:
      2.3.2.1. Try adding this order to every possible position of every route,
      2.3.2.2. Remove choices where:
        2.3.2.2.1. The order increases the route size past the target route
            size AND increases avg. cost per order.
        2.3.2.2.2. The order increases the route size past 4/3rds
            (133.33%) of the target route size.
        2.3.2.3. See which available position increases the route cost the least
            (using the penalty adjusted cost).
        2.3.2.4. Add the order to this position of this route.
    2.3.3. Offer new integration routes to subject couriers.
  [Note: No remove-reinsertion needed.]
  [Note: An AI routing module can be substituted for 2,3.2 with the command
  “INTEGRATE_ORDERS” by plugging in in the appropriate fields (Assigned routes
  or Offered Integration Routes for pre-assigned route input).
  2.4. Locate contract workers that are available and offer bundles to them (to max
  capacity until no orders are left or no more available contract worker couriers).
    2.4.1. Target route size is automatically set to be = remaining subject orders /
        vehicle capacity. (Minimize contract workers used)
    2.4.2. Create routes (create empty lists: # of routes = Total # subject orders /
        target route size)
    2.4.3. (Run mini-algorithm to get things started) For each route
      2.4.3.1. Go through every subject order, see which one starts the route
          off with the smallest route cost, add that order to the route, remove it
          from the subject order pool.
    2.4.4. For each order in the subject pool:
      2.4.4.1. Try adding this order to every possible position of every route,
      2.4.4.2. Remove choices where:
      2.4.4.2.1. The order increases the route size past the target route
            size AND increases avg. cost per order.
      2.4.4.2.2. The order increases the route size past 4/3rds
            (133.33%) of the target route size.
      2.4.4.3. See which available position increases the route cost the least
            (using the penalty adjusted cost).
      2.4.4.4. Add the order to this position of this route.
  2.4.5. (Remove-reinsertion optimization algorithm) For every order in every
      route:
  2.4.5.1. Remove order from its route
  2.4.5.2. Rerun 2.4.4 with order (reinsert it into the available
      route/position with the lowest increase in route cost).
  2.4.6. Rank all routes by urgency (group each order 1 -3 and compare group
      average of routes)
  2.4.6.1. Rank I - orders with drop-off time impossible to achieve
  2.4.6.2. Rank II - orders not in I that cannot be picked up at ready time
  2.4.6.3. Rank III - orders not in group Deadline
  2.4.7. Assign most urgent routes, discard the rest (to spill over into the next
      pool).
  2.4.8. Utilize contract worker assignment algorithm to determine which
      contract workers get picked for the chosen routes.
  (Note: The AI can substitute 2-6 with the command ″BUILD_NEW_ROUTE″ by
  plugging in the appropriate fields.]
  2.5. The rest of the orders are discarded (and left unassigned).
```

Returning to FIG. 13 (input K), if the orders selected by a system manager have been previously assigned to a courier, an automatic transfer epoch (subroutine 1306) is initiated. According to the manual assignment epoch (subroutine 1304). In an automatic transfer epoch, if employee couriers are available, the orders are first converted into the minimum number of bundles within the target carrying capacity in a form that minimizes route cost and those bundles are then each assigned to an available employee courier. These couriers will be directed to pick up the bundle orders directly from the courier transferring the in-transit orders rather than from the depot. If there are no employee couriers available (or there are an insufficient number to handle all selected orders), an algorithm determines an active route and index at which to integrate each of the selected orders among available couriers to minimize increase in total route cost. Integration bundles are then created and assigned to the algorithmically determined employee couriers. An integration bundle reflects the addition of orders to a bundle after the initial bundle has been assigned, but not yet picked up at the depot. The goal is to try to assign all the orders available at a depot for delivery, preferably by employee couriers. Assignment of an integration bundle would be reflected in an update of a courier's delivery map that includes additional orders beyond those in the original bundle assignment. If there are no employed couriers available or active, the same process is repeated but with contract couriers. In this case, all bundles are provisional, to be accepted or rejected by the contracted courier at their own discretion. In either circumstance, the subject orders are immediately removed from the route of the original courier transferring the orders, to be returned only if the provisional route is rejected or the pickup is canceled by the pickup courier. If there are no available or active employees or couriers to handle the transfer pickup, no action is performed. Table 3 below is an example of pseudo code for an implementation of an automatic transfer epoch (subroutine 1306).

```
TABLE 3
3.0 Automatic Transfer Epoch:
  3.1. Locate all available employees and assign transfer bundles to them (to max
      capacity)
      3.1.1. Target route size is automatically set to be = remaining subject orders /
          max vehicle capacity. (Minimize employees used)
      3.1.2. If there’s just one of these couriers: orders are assigned as a regular
          transfer pickup (calls Fig. 16 (operation 1608))
        3.1.2.1. Otherwise, determines the number of routes:
        3.1.2.2. (Rounded up) # of orders being transferred / target route size
        3.1.2.3. # of available employees
      3.1.3. The smallest number of these two is chosen for the number of routes.
      3.1.4. (It essentially runs a version of 3.1.1 except where the assigned routes
          are assigned transfer routes and the pickup location is the transfer
          location (transfer index is 0 (immediately))
      3.1.5. Build & assign these transfer routes
      3.1.6. Retract these orders from the assigned route of the transferring courier
      [Note: The AI can substitute 3.1.4 with the command “TRANSFER_ORDERS”
      by plugging in the appropriate fields (empty pickup courier routes for the pre-
      existing route inputs)]
  3.2. Locate all employees that haven’t yet picked up their orders and assign
      transfer bundles to them (retracting their previous assigned bundle) (to max
      capacity)
      3.2.1. With the remaining subject transfer orders: retract all un-picked up
        orders of all couriers in this group
      3.2.2. Run 3.7.1 with those who now have no assigned orders.
      3.2.3. Run 3.7.3 for the other couriers that still have picked-up assigned
          orders, (which won’t be retracted) (rare path: requires some orders
          picked up, and some not)
  3.3. Locate all employees that are currently delivering orders and assign transfer
      bundles to them (to max capacity)
      3.3.1. Target route size is automatically set to be = remaining subject orders /
        max vehicle capacity
      3.3.2. For every remaining order being transferred:
        3.3.2.1. Try adding the order to every possible position of every pre-
            route,
        3.3.2.2. Remove choices where:
          3.3.2.2.1. The order increases the route size past the target route
            size AND increases avg. cost per order.
          3.3.2.2.2. The order increases the route size past 4/3rds
            (133.33%) of the target route size.
        3.3.2.3. See which available position increases the route cost the least
          (using the penalty adjusted cost).
        3.3.2.4. Add the order to this position of this route.
      3.3.3. Remove transferred orders from the pickup routes (but keep them
          paired to those routes)
      3.3.4. Call a transfer pickup (calls Fig. 16 (operation 1608)) with each pickup
          courier and their paired transfer orders (if they have any), so that an
          efficient route & transfer index may be assigned with them.
    [Note: The AI can substitute 3.3.2-3.3.4 with the command
    “TRANSFER_ORDERS” by plugging in the appropriate fields (pickup courier
    pre-existing assigned routes for the pre-existing route inputs)]
  3.4. Locate all available contractors and assign transfer bundles to them (to max
      capacity)
      3.4.1. Target route size is automatically set to be = remaining subject orders /
          max vehicle capacity. (Minimize employees used)
      3.4.2. If there’s just one of these contract couriers: orders are assigned as a
          regular transfer pickup (calls Fig. 16 (operation 1608))
        3.4.2.1. Otherwise, determines the number of routes:
        3.4.2.2. (Rounded up) # of orders being transferred / target route size
        3.4.2.3. # of available contractors
      3.4.3. The smallest number of these two is chosen for the number of routes.
      3.4.4. (It essentially runs a version of 3.1.1 except where the assigned routes
          are assigned transfer routes and the pickup location is the transfer
          location (transfer index is 0 (immediately))
      3.4.5. Build & assign these transfer routes
      3.4.6. Retract these orders from the assigned route of the transferring
          contract courier
      [Note: The AI can substitute 3.1.4 with the command “TRANSFER_ORDERS”
      by plugging in the appropriate fields (empty pickup courier routes for the pre-
      existing route inputs)]
  3.5. Locate all contractors that haven’t yet picked up their orders and assign
      transfer bundles to them (retracting their previous assigned bundle) (to max
      capacity)
      3.5.1. With the remaining subject transfer orders: retract all un-picked up
          orders of all contractor couriers in this group
      3.5.2. Run 3.7.1 with those who now have no assigned orders.
      3.5.3. Run 3.7.3 for the other contractor couriers that still have picked-up
          assigned orders, (which won’t be retracted) (rare path: requires some
          orders picked up, and some not)
  3.6. Locate all contractors that are currently delivering orders and assign transfer
  bundles to them (to max capacity)
      3.6.1. Target route size is automatically set to be = remaining subject orders /
          max vehicle capacity
      3.6.2. For every remaining order being transferred:
        3.6.2.1.  Try adding the order to every possible position of every pre-
            route,
        3.6.2.2. Remove choices where:
          3.6.2.2.1. The order increases the route size past the target route
                size AND increases avg. cost per order.
          3.6.2.2.2. The order increases the route size past 4/3rds
                (133.33%) of the target route size.
        3.6.2.3. See which available position increases the route cost the least
            (using the penalty adjusted cost).
        3.6.2.4. Add the order to this position of this route.
      3.6.3. Remove transferred orders from the pickup routes (but keep them
          paired to those routes)
      3.6.4. Call a transfer pickup (calls Fig. 16 (operation 1608)) with each pickup
            contractor courier and their paired transfer orders (if they have any), so
            that an efficient route & transfer index may be assigned with them.
        [Note: The AI can substitute 3.3.2-3.3.4 with the command
        “TRANSFER_ORDERS” by plugging in the appropriate fields (pickup courier
        pre-existing assigned routes for the pre-existing route inputs)]
```

The automatic transfer epoch algorithm will try to minimize how many additional couriers are involved in a transfer, so the goal is to maximize the capacity of all additional couriers involved and make sure that every courier group is filled with orders, while still having transfer orders left over, before moving on. In this sense, additional transfer orders “spill over” into the next group like a waterfall fountain. In response to a transfer order, the automatic transfer epoch algorithm calls either regular route-making algorithms or integration route-making algorithms depending on the circumstances.

The following is an example priority list for automatic transfer epoch route-making routines (for the courier that is assigned a transfer):

First Priority—employee couriers that are online and available (runs 1 routine per vehicle type in priority order).
a. The assigned transfer orders will now become their entire bundle.

Second Priority—employee couriers that are online and have not yet picked up their assigned orders (runs 1 routine per vehicle type in priority order).
a. Their current assigned orders will be retracted. The assigned transfer orders will now become their entire bundle.

Third Priority—employee couriers that are online and are in the middle of delivering orders (runs 1 routine per vehicle type in priority order).
a. The transfer orders will be integrated efficiently into their pre-existing routes.

For the contract couriers, the priority order is different, favoring contract workers already currently fulfilling a contract above resting ones. For example, since contracting a new contract courier could activate a minimum wage guarantee, it is better to ask as contract courier that's already accepted a delivery. Thus, the priority order continues with respect to contract couriers as follows:

Fourth Priority—contract couriers that are online and have not yet picked up their assigned orders (runs 1 routine per vehicle type in priority order).
a. Upon acceptance, their current assigned orders will be retracted. The assigned transfer orders will now become their entire bundle.

Fifth Priority—contract couriers that are online and are in the middle of delivering orders (runs 1 routine per vehicle type in priority order).
a. The transfer orders will be integrated efficiently into their pre-existing routes.

Fifth Priority—contract couriers that are online and available (runs 1 routine per vehicle type in priority order).
a. Contract couriers being offered bundles at the same time will also fall into this category. The transfer offer will override their current offer in this case.

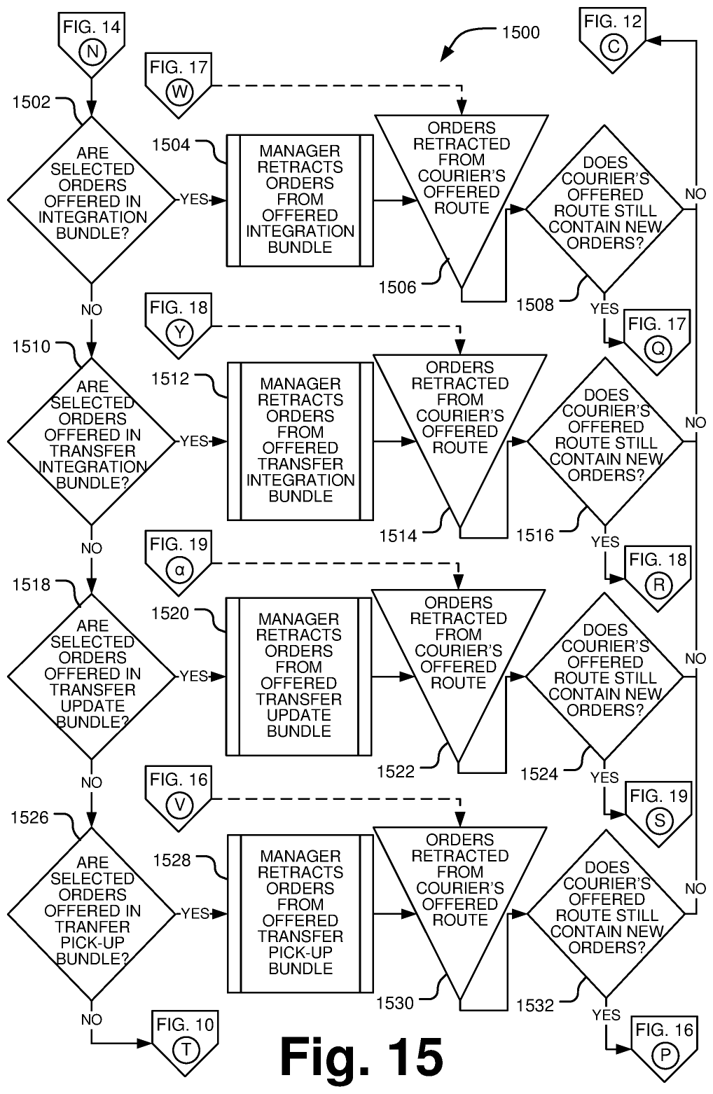

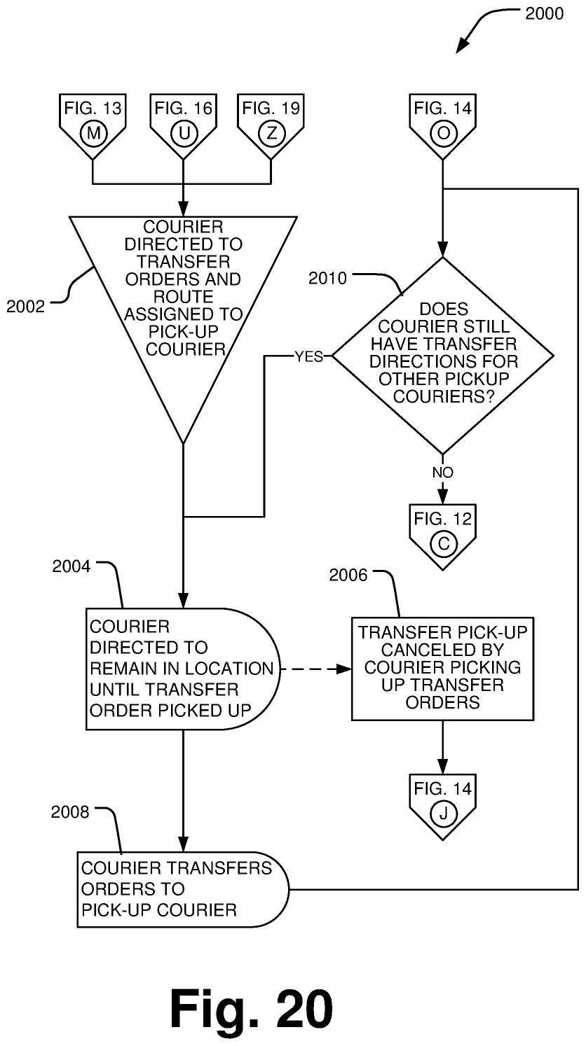

Returning to FIG. 13, once the automatic transfer epoch has completed the determination of which couriers should receive transfers and updated routes for both the receiving couriers and transferring couriers, the process 1300 moves to FIG. 16 (input M) for further direction of a courier receiving a transferred order and to FIG. 20 (input M) for a courier transferring an order. These process steps will be described in detail further herein. However, the process of retraction of orders by a manager or by the automatic transfer epoch in order to provide orders for transfer to other couriers will first be described primarily with respect to FIGS. 14 and 15.

FIG. 14 depicts a process 1400 by which orders are retracted from courier bundles for reassignment. Input for the process 1400 may initially be in the form of orders identified in the retraction command (action 1112 From FIG. 11) actuated by a courier manager. Other points of input from other parts of the system will be further described below. The process 1400 first determines whether orders selected and marked retracted are already assigned to a courier (operation 1402). If the orders selected for retraction are not assigned to a courier, the process further determines whether the selected orders are presently offered to a contractor courier for acceptance (operation 1404). If this is also not the case, then the selection of the orders for retraction was likely in error and the process returns to FIG. 11 (input Ω) where the status of the order is changed to unselected and the order is again available for selective management. If the order is, in fact, pending acceptance, the process transfers to FIG. 15 (input N) for further management of the retraction depending upon what type of bundle of orders that the retracted order is in to ensure that the transfer is managed appropriately.

Returning to operation 1402, if instead the orders selected for retraction are, in fact, already assigned to a courier, the process 1400 further determines whether or not the selected orders are in the process of being transferred from the present courier to a third courier (operation 1406). If the order is not being transferred from a bundle previously assigned to another carrier, the status of any order selected for retraction will immediately be changed to unassigned and available for allocation in a new bundle (operation 1412). Orders that are retracted are further removed from a courier's assigned route (operation 1414). The process returns the courier to FIG. 12 (input C) for a determination of whether the courier has more assigned orders on the assigned route and directs the courier to complete delivery of those orders if so.

Returning to operation 1406, if it is determined that selected orders had, in fact, previously been assigned for transfer to a third courier, the process 1400 instantly rescinds the selected orders for purposes of that transfer (operation 1408), and integrates the orders back into the route of the original courier that was to transfer the order (operation 1410). As noted in the diagram of FIG. 14, input to operation 1408 may come from other processes in the system, for example FIG. 18 (input X). Similarly, inputs to operation 1410 may come from various other processes in the system, for example, input J from FIGS. 12 and 19. Once a transfer order is retracted and returned to the route of the originally assigned courier, the process may continue to FIG. 20 (input O) to consider route shifts in view of previously scheduled intercepts with another courier for the transfer.

FIG. 15 depicts the process flow 1500 for determination of how to handle retracted orders when they are in a state of being offered to a contract courier before the contract courier accepts the offer and, particularly, when only some, but not all, of the orders in the offered order bundle are retracted. Initiation of the flow comes from FIG. 14 (input N). Initially, a determination is made as to whether the offered orders selected for retraction are part of an integration bundle (operation 1502) in which new unassigned orders are integrated into an assigned route. If so, the retraction command from the manager will instantly rescind the selected orders from the currently offered route and the rescinded orders will convert back to unassigned orders (operation 1504). The orders disappear from the route offered to the contract courier (operation 1506). The process then determines whether the offer to the courier still includes new orders for delivery due to the integration algorithm (operation 1508). If so, the process moves to FIG. 17 (input Q) to revise the integration offer presented to the contract carrier. If not, the process returns to FIG. 12 (input C) to determine whether the contract courier has any further orders to deliver on an already accepted delivery contract and continues to direct delivery thereof. It may be noted that an alternative input into the retraction from the route (operation 1506) may come from FIG. 17 (input W) in the event that additional orders are retracted from the revised offered integration bundle before the contract courier accepts the revised offer in FIG. 17.

If a determination is made that the offered orders selected for retraction are not part of an integration bundle (operation 1502), the process 1500 may make a further determination as to whether the offered orders selected for retraction are orders offered in a transfer integration bundle (operation 1510), which integrates orders retracted from another courier into the assigned route. If so, the retraction command from the manager will instantly rescind the selected orders from the currently offered route and will integrate the rescinded orders back into the route of the original courier from whom the order was being transferred (operation 1512). The orders disappear from the route offered to the contract courier (operation 1514). The process then determines whether the offer to the courier still includes new orders for delivery due to the integration algorithm (operation 1516). If so, the process moves to FIG. 18 (input R) to revise the transfer integration offer presented to the contract carrier. If not, the process returns to FIG. 12 (input C) to determine whether the contract courier has any further orders to deliver on an already accepted delivery contract and continues to direct delivery thereof. It may be noted that an alternative input into the retraction from the route (operation 1514) may come from FIG. 18 (input Y) in the event that additional orders are retracted from the revised offered transfer integration bundle before the contract courier accepts the revised offer in FIG. 18.

If a determination is made that the offered orders selected for retraction are not part of a transfer integration bundle (operation 1510), the process 1500 may make a further determination as to whether the offered orders selected for retraction are orders offered in a transfer update bundle (operation 1518), which integrates new transfer orders into an existing transferred route. If so, the retraction command from the manager will instantly rescind the selected orders from the currently offered route and will integrate the rescinded orders back into the route of the original courier from whom the order was being transferred (operation 1520). The orders disappear from the route offered to the contract courier (operation 1522). The process then determines whether the offer to the courier still includes new orders for delivery due to the integration algorithm (operation 1524). If so, the process moves to FIG. 19 (input S) to revise the transfer integration offer presented to the contract carrier. If not, the process returns to FIG. 12 (input C) to determine whether the contract courier has any further orders to deliver on an already accepted delivery contract and continues to direct delivery thereof. It may be noted that an alternative input into the retraction from the route (operation 1520) may come from FIG. 19 (input α) in the event that additional orders are retracted from the revised offered transfer update bundle before the contract courier accepts the revised offer in FIG. 19.

If a determination is made that the offered orders selected for retraction are not part of a transfer update bundle (operation 1518), the process 1500 may make a further determination as to whether the offered orders selected for retraction are orders offered in a transfer pickup bundle (operation 1526), which integrates transferred orders and a new pickup from a depot into an assigned route. If so, the retraction command from the manager will instantly rescind the selected orders from the currently offered route and will integrate the rescinded orders back into the route of the original courier from whom the order was being transferred (operation 1528). The orders disappear from the route offered to the contract courier (operation 1530). The process then determines whether the offer to the courier still includes new orders for delivery due to the integration algorithm (operation 1532). If so, the process moves to FIG. 16 (input P) to revise the transfer integration offer presented to the contract carrier. If not, the process returns to FIG. 12 (input C) to determine whether the contract courier has any further orders to deliver on an already accepted delivery contract and continues to direct delivery thereof. It may be noted that an alternative input into the retraction from the route (operation 1528) may come from FIG. 16 (input V) in the event that additional orders are retracted from the revised offered transfer pickup. If a determination is made that the offered orders selected for retraction are not part of a transfer pickup bundle (operation 1526), the process 1500 may return to FIG. 10 (input T) wherein the retraction of orders is made from an initial offered bundle (operation 1020).

FIGS. 16-20 describe operations for handling of the various order transfer scenarios between couriers. FIG. 16 depicts the process 1600 of managing immediate transfer pickup of assigned or offered orders. For example, if selected orders are assigned and already picked up by the assigned courier, but then the manager drag-and-drops one or more of those orders directly onto a second courier (aka a “pickup courier”), an immediate transfer pickup request is assigned and a transfer route needs to be created. A first access point to this process 1600 comes from FIG. 11 (input Δ) by which a transfer has been initiated between couriers with assignments or offers for bundles. Initially, a determination is made as to whether the courier has previously been offered a transfer pickup bundle (operation 1602). If not, then the system creates a new transfer pickup assignment (subroutine 1604). The algorithm creates new routes for both the pickup courier and the original courier in order to effect a physical transfer of the orders from one to the other. The transfer pickup assignment varies slightly depending upon whether the pickup courier is an employee or a contractor.

In the case of employed couriers, the pickup courier and the original courier are directed to travel to a point within the pickup courier's route deemed most convenient by a separate routing algorithm. An example of such routing is presented in FIG. 20 (referenced by direction to FIG. 20 (input U) in FIG. 16). Transferred orders are then integrated into the pickup courier's post-pickup route with the goal of minimizing the increase in route cost of the pickup courier. The subject orders are immediately removed from the route of the initial courier transferring the orders. This pickup can be canceled if the pickup courier decides for some reason to decline the pickup. In this case, the orders revert to the original courier. As noted in FIG. 16, if for some reason the orders cannot be returned to the original courier (e.g., the original courier has completed delivery of all other orders or received a new bundle), the orders selected for transfer maybe returned to unselected status as indicated in FIG. 11 (input Ω) for new automatic assignment. In the context of management of couriers, orders, and routes through the order management GUI, this same action is also performed when and if the selected assigned orders are dropped directly onto a specific portion of the secondary pickup courier's route (i.e., the line connecting orders A and B). In this case, only the selected orders shall be inserted specifically between orders A and B in a way that minimizes increase in route cost given this constraint (rather than the algorithm recalculating the entire route for placement of the transferred orders most efficiently). If this pickup is canceled by the second pickup courier, the orders selected for transfer are reinserted into the route of the initial courier.

In the case of a manger dragging-and-dropping orders from an original courier directly onto a second courier that is a contractor, an immediate transfer pickup is offered to the contract courier and a provisional transfer route is created. If accepted, the pickup courier and the original courier are directed to travel to a point within the pickup courier's route deemed most convenient by a separate routing algorithm. Transferred orders are integrated into the pickup courier's provisional post-pickup route with the goal minimizing the increase in the pickup courier's provisional route cost. The subject orders are immediately removed from the route of the courier transferring the orders, to be returned if the provisional route is rejected by the pickup courier. This action is also performed when selected unassigned orders are dropped directly onto a portion of the pickup courier's route (i.e., the line connecting orders A and B). In this case, only the selected orders shall be provisionally inserted specifically between orders A and B in a way that minimizes increase in the provisional route cost given this constraint. If after accepting the transfer order, the pickup courier cancels the pickup, the orders selected for transfer are reinserted into the route of the original courier. As noted in FIG. 16, if for some reason the orders cannot be returned to the original courier (e.g., the original courier has completed delivery of all other orders or received a new bundle), the orders selected for transfer maybe returned to unselected status as indicated in FIG. 11 (input Ω) for new automatic assignment.

Table 4 below is an example of pseudo code for an implementation of a transfer pickup assignment (subroutine 1306) that may for the basis for either an employee courier or contract courier order transfer operation.

```
TABLE 4
4.0 Immediate Transfer Pickup:
      [Note: For this algorithm, both a ‘Transferring Courier’ and a ‘Pickup Courier’
      have already been chosen. Vehicle Capacity is ignored. Not only do all
      transfer orders need to be inserted into the pickup courier’s route, an efficient
      pickup point needs to be established in the pickup courier’s route with all
      transfer order drop offs only being inserted into the route after this moment.]
4.1. All orders for a pickup courier that haven’t been picked up are retracted, (i.e.
      “If you haven’t picked up your assigned orders yet, don’t bother”)
4.2. If the pickup courier has previously been offered an integration, transfer
      integration, or just a regular route, that has not been accepted, the offer is
      retracted.
4.3. For every possible transfer index of the pickup courier’s route (route size +1):
      [Note: The transfer Index is a number located between two drop-off points in a
      route. Before heading to the drop-off point at this index, the pickup courier
      must immediately head to the location of the transferring courier to pick up
      transfer orders, before continuing to drop off the orders in their route.
      (Transfer index of 0 means “immediately”, transfer index of 1 means “after 1
      drop-off”)]
    4.3.1. Two lists are created: ‘Pre-pickup route’ and ‘Post-pickup route’
    4.3.2. For every order in the pickup couriers route:
      4.3.2.1. If its index < the current index
        4.3.2.1.1. Add it to the Pre-pickup route
      4.3.2.2. Else
        4.3.2.2.1. Add it to the Post-pickup route
    4.3.3. For every order that is being transferred:
      4.3.3.1. Try adding this order to every possible position of this route,
      4.3.3.2. See which available position increases the route cost the least
          (using the regular route cost (no penalty adjustment)).
      4.3.3.3. Add the order to this position of this route.
4.4. See which transfer route (transfer index and post-pickup route combo) has the
    lowest score (using the regular route cost (no penalty adjustment)).
4.5. Build this transfer route
    4.5.1. Assign it if the pickup courier is an employee (assigned transfer route)
    4.5.2. Offer it if the pickup courier is a contract worker (offered transfer route)
4.6. Retract these orders from the assigned route of the transferring courier
      [Note: The AI can substitute 4.2-4.4 with the command
      “TRANSFER_ORDERS” by plugging in the appropriate fields (pickup courier
      pre-existing assigned routes for the pre-existing route inputs)]
```

Returning to FIG. 16, if the courier has previously been offered a transfer pickup bundle (operation 1602), then a further determination is made as to whether the orders presently offered for immediate transfer pickup are also being transferred from the same original courier as the previous transfer pickup offer (operation 1606). If not, the transfer pickup offer is not implemented by the system, the orders selected for transfer pickup are rescinded from the original courier, and the status of the orders is changed to “unselected” so that they can be immediately reassigned by a system manager as indicated by the direction to FIG. 11 (input Ω). While it may make sense to transfer more orders between the same two couriers, requesting two separate transfer pickups by a single pickup courier from two different original couriers is unlikely to lead to any efficiency in delivery of orders, so the system may be configured to disregard such a request in the first place.

However, if the second transfer pickup assignment or request to a pickup courier is for orders held by the same original courier, and the couriers have not intercepted each other yet for a transfer of goods, the addition of transfer orders from the original courier to the pickup courier makes sense. In the context of management of couriers, orders, and routes through the order management GUI, if the selected orders are currently assigned, and the client drag-and-drops directly onto a contracted courier (to whom the original courier currently assigned the selected orders for delivery is also provisionally transferring), the selected orders are added to the pre-existing transfer offer and are thus integrated into the pickup courier's provisional post-pickup route with the goal of minimizing an increase in the pickup courier's provisional route cost. The subject orders are immediately removed from the route of the original courier transferring the orders, to be returned if the provisional route is rejected or the pickup is canceled by the pickup courier. This action is also performed when selected unassigned orders are dropped directly onto a portion of the pickup courier's route (i.e., the line connecting orders A and B). However, the selected orders shall instead be provisionally inserted specifically between orders A and B in a way that minimizes increase in the provisional route cost given this new constraint.

An algorithm similar to the one presented in Table 4 can serve as the basis for a process integrating a second transfer pickup order into a prior transfer pickup order from the same original courier (operation 1608). The algorithm of Table 4 can be run a second time with all proposed transfer orders (old and new) and the pickup courier's revised route after processing the first pickup transfer request, and replaces the previous transfer pickup offer with a new one. Once the system has either created a new transfer pickup assignment and route (operation 1604) or integrated two transfer orders into a single pickup bundle from an original courier with a revised route for the pickup carrier (operation 1608), the courier is presented with the transfer pickup bundle for delivery and a revised route on the courier's mobile device (operation 1610).

The process 1600 next determines whether the pickup courier is an employee or a contractor (operation 1612). If the pickup courier is an employee, the process for the employee courier immediately reverts to the standard bundle assignment and delivery process of FIG. 12 (input B). If, instead, the courier is a contractor, the process proceeds to formally offer the transfer pickup bundler to the contractor as a contract assignment (operation 1614). It should be noted that the additional flow from FIG. 15 (input P) may also be received at operation 1614 to offer a contract to the contractor courier at that point in the process of FIG. 15. From operation 1614, the process then determines whether the contract courier actually accepts the offer (operation 1616). If the contract courier accepts the offer, then the process immediately reverts to the standard bundle assignment and delivery process of FIG. 12 (input B). If the contract courier declines the offer, then the process for the courier immediately reverts to FIG. 12 (input C) for a determination of whether or not the contract courier has accepted other orders for delivery and proceeds from there. In addition, if before the contract courier accepts the pickup transfer orders, the manager retracts the orders, the process could be redirected to FIG. 15 (input V) in the alternate scenario flowing from operation 1614 in FIG. 16.

FIG. 17 depicts the process 1700 of managing requests to integrate new unassigned orders into a currently assigned contract courier route. This is considered an “integration bundle” in the parlance of this system. For example, in the context of management of couriers, orders, and routes through the order management GUI, the process is performed in response to a manager drag-and-drop of selected unassigned orders directly onto a contracted courier that is not available, but also has assigned orders that are yet to be picked up from the depot. A proposed bundle is created with the selected orders integrated into the existing route in a way that minimizes the increase in route cost. The new bundle is offered to the courier as a proposed update to their current assigned bundle. This action is also performed when selected unassigned orders are dropped via the GUI directly onto a specific portion of the subject courier's route (i.e., the line connecting orders A and B). In this case, only the selected orders shall be inserted specifically between orders A and B in a way that minimizes increase in the route cost given this constraint.

A first access point to this process 1700 comes from FIG. 11 (input θ) by which it is noted that a courier has currently assigned orders. Again this process presumes the contractor courier already has assigned orders. Initially, a determination is made as to whether the courier has previously been offered an order bundle, but has not yet accepted (operation 1702). If not, then the system creates a new integration bundle to include the previously unassigned orders (subroutine 1704). This process is usually performed before any of the assigned orders are picked up because new order pick-ups will be assigned. However, the process can be implemented after initial pickup of the original orders from the depot. The courier will just be directed back to the depot to retrieve the additional orders. This integration bundle creation process 1704 may be implemented in the AI model using an action ‘INTEGRATE_ORDERS’, and the inputs are the assigned route plus a list of unassigned orders. Alternatively, implementation in a heuristic model may include testing each integration order in every position of the built route, and its position is chosen to be where there is the minimum increase in route cost. For an employee, the new bundle is instantly assigned. For a contract worker, the new bundle is offered as an ‘offered integration bundle’ for acceptance. Note that depending upon whether the courier is a contractor or employee, two different routes may be developed: and assigned employee route, and a contractor offered route. The routes are usually mostly the same, but may have deviations due to, for example, different starting locations and different weighting given to employees vs. contractors.

Returning to the decision of operation 1702, if the contract courier has a presently pending offer, but no actual assigned order bundles, a slightly different algorithm is used to integrate additional selected orders into the proposed delivery contract (operation 1706). For example, in the context of management of couriers, orders, and routes through the order management GUI, the process is performed in response to a manager drag-and-drop of selected unassigned orders directly onto a contracted courier that is not available, but has offered delivery orders that have not yet been accepted. An offer to deliver a proposed bundle is created with the selected orders integrated into the proposed route of the prior delivery bundle offer in a way that minimizes the increase in route cost. The new bundle is offered to the courier as a proposed update to their current bundle offer. This action is also performed when selected unassigned orders are dropped via the GUI directly onto a specific portion of the proposed route of the original bundle offer (i.e., the line connecting orders A and B). In this case, only the selected orders shall be provisionally inserted specifically between orders A and B in a way that minimizes increase in the provisional route cost given this constraint. Note that this is a contract worker exclusive action. It is invoked when the courier is already offered an integration route, and the merchant then wants to add more orders to it before the courier has accepted. This new offer replaces the previous offer, thereby updating the terms of an offered integration bundle.

This integration bundle offer creation process 1706 may be implemented in the AI model using an action ‘INTEGRATE_ORDERS’, and the inputs are the offered integration route plus a list of unassigned orders. Alternatively, implementation in a heuristic model may include testing each integration order in every position of the built route, and its position is chosen to be where there is the minimum increase in route cost. The new offered integration route offer immediately replaces the previous offered integration route and continues to await the response of the subject contract worker courier. Once the system has either created a new integration assignment and route (operation 1704) or integrated new unassigned orders into an existing offered integration bundle with a revised route for the carrier (operation 1706), the courier is presented with the integration bundle for delivery and a revised route on the courier's mobile device (operation 1708).

The process 1700 next determines whether the courier is an employee or a contractor (operation 1710). If the courier is an employee, the process for the employee courier immediately reverts to the standard bundle assignment and delivery process of FIG. 12 (input B). If, instead, the courier is a contractor, the process proceeds to formally offer the integration bundle to the contractor as a contract assignment (operation 1712). It should be noted that the additional flow from FIG. 15 (input Q) may also be received at operation 1712 to offer a contract to the contractor courier at that point in the process of FIG. 17. From operation 1712, the process then determines whether the contract courier actually accepts the offer (operation 1714). If the contract courier accepts the offer, then the process immediately reverts to the standard bundle assignment and delivery process of FIG. 12 (input B). If the contract courier declines the offer, then the process for the courier immediately reverts to FIG. 12 (input C) for a determination of whether or not the contract courier has accepted other orders for delivery and proceeds from there. In addition, if before the contract courier accepts the integration orders, the manager retracts the orders, the process could be redirected to FIG. 15 (input W) in the alternate scenario flowing from operation 1712 in FIG. 17.

FIG. 18 depicts the process 1800 of managing requests to integrate transfer orders assigned to another courier that have not been picked up yet and remain at a depot. This is considered a “transfer integration bundle” in the parlance of this system. For example, in the context of management of couriers, orders, and routes through the order management GUI, the process is performed in response to a manager drag-and-drop of assigned orders from one courier to a second courier. The second courier may not have any assignments or, if they do have assigned orders, they have not been picked up yet. All the orders are integrated into the second courier's route in such a way as to minimize increase in the pickup courier's route cost. The subject orders are immediately removed from the route of the courier transferring the orders, to be returned if the pickup is canceled by the second courier.

The process is slightly modified for contract couriers as opposed to employee couriers. If the selected orders are currently assigned to a first courier and have not been picked up from their depot, and further if the selected orders are drag-and-dropped directly onto a second contract courier who either has no orders or has yet to pick up their assigned orders, a provisional transfer-integration bundle is created. The selected orders are integrated into the second courier's provisional route in such a way as to minimize increase in the pickup courier's provisional route cost. The subject orders are immediately removed from the route of the original courier transferring the orders, to be returned if the provisional route is rejected or the pickup is canceled by the second courier.

A first access point to this process 1800 comes from FIG. 11 (input Φ) by which it is noted that a courier has not yet picked up their assigned orders. Initially, a determination is made as to whether the courier has previously been offered a transfer integration order bundle, but has not yet accepted (operation 1802). If not, then the system creates a new transfer integration bundle to integrate the carrier's previously assigned orders and the orders to be transferred (subroutine 1804). This process is usually performed before any of the assigned orders are picked up because new order pick-ups will be assigned. However, the process can be implemented after initial pickup of the original orders for the second courier from the depot. The second courier will just be directed back to the depot to retrieve the additional orders.

This transfer integration bundle creation process 1804 may be implemented in a similar manner to the process described with respect to operation 1704 in FIG. 17. Note, this is like a transfer pickup but for transfer orders that haven't been picked up yet. Because no actual transfer is involved here, this is seen as less of an ‘emergency’ and more of a last minute switch between couriers that haven't picked up their orders yet. Therefore, the pickup couriers pre-existing un-picked up orders will not be retracted to make room for the transfer orders. Rather, the transfer orders will be integrated into the courier's route in such a way as to minimize an increase in cost. If the pickup courier is an employee, the new route is assigned. If the pickup courier is a contract worker, the new route is offered. Unlike operation 1704 in FIG. 17, if these orders are rejected, they are returned to the previous courier they were assigned to, not unassigned.

Returning to FIG. 18, if the courier has previously been offered a transfer integration bundle (operation 1802), then a further determination is made as to whether the orders presently offered for transfer integration are also being transferred from the same original courier as the transfer integration offer (operation 1806). If not, the transfer integration offer is not implemented by the system, the orders selected for transfer integration may be either rescinded or returned from the original courier, and, if rescinded, the status of the orders is changed to “unselected” so that they can be immediately reassigned by a system manager as indicated by the direction to FIG. 11 (input Ω).

If the transfer orders offered for integration are from the same courier, then a slightly different algorithm is used to integrate additional transferred integration bundles into the proposed delivery contract (operation 1808). As above, this transfer integration bundle creation process 1804 may be implemented in a similar manner to the process described with respect to operation 1704 in FIG. 17. For example, in the context of management of couriers, orders, and routes through the order management GUI, the process is performed in response to a manager drag-and-drop of orders from the original courier directly onto a second contracted courier (to whom the courier currently delivering the selected orders is also currently provisionally transferring), selected orders are added to the pre-existing transfer integration offer and are thus integrated into the second courier's provisional transfer integration route with the goal of minimizing an increase in the pickup courier's provisional route cost. The subject orders are immediately removed from the route of the original courier transferring the orders, to be returned if the provisional transfer update route is rejected. This action is also performed when selected unassigned orders are dropped directly onto a portion of the pickup courier's route (i.e., the line connecting orders A and B); however, the selected orders shall instead be provisionally inserted specifically between orders A and B in a way that minimizes increase in the provisional transfer update route cost given this constraint. Upon completion of a transfer pickup, the selected orders are removed from the original courier transferring the order.

The new transfer integration bundle route offer immediately replaces the previous offered transfer integration bundle route and continues to await the response of the subject contract worker courier. Once the system has either created a new transfer integration assignment and route (operation 1806) or integrated new transfer orders into an existing offered integration transfer bundle with a revised route for the carrier (operation 1808), the courier is presented with the transfer integration bundle for delivery and a revised route on the courier's mobile device (operation 1810).

The process 1800 next determines whether the courier is an employee or a contractor (operation 1812). If the courier is an employee, the process for the employee courier immediately reverts to the standard bundle assignment and delivery process of FIG. 12 (input B). If, instead, the courier is a contractor, the process proceeds to formally offer the integration transfer bundle to the contractor as a contract assignment (operation 1814). It should be noted that the additional flow from FIG. 15 (input R) may also be received at operation 1814 to offer a contract to the contractor courier at that point in the process of FIG. 18. From operation 1814, the process then determines whether the contract courier actually accepts the offer (operation 1816). If the contract courier accepts the offer, then the process immediately reverts to the standard bundle assignment and delivery process of FIG. 12 (input B). If the contract courier declines the offer, then the process for the courier immediately reverts to FIG. 12 (input C) for a determination of whether or not the contract courier has accepted other orders for delivery and proceeds from there. In addition, at this point a simultaneous process is initiated in FIG. 14 (input J) to retract the offered integration transfer orders and return the courier to the original transfer instructions offered. Further, if before the contract courier accepts the integration orders, the manager retracts the orders, the process could be redirected to FIG. 15 (input Y) in the alternate scenario flowing from operation 1814 in FIG. 18.

FIG. 19 depicts the process 1900 of managing requests to add orders to an assigned transfer pickup. Not to be confused with the process of FIG. 16, this action is called when the contract courier has already accepted the transfer pickup request and made it assigned, then subsequently new orders are proposed for the same transfer. This creates a brand new offer known as an offered transfer pickup update in the parlance of this system. In an example, in the context of management of couriers, orders, and routes through the order management GUI, the process is performed in response to a manager drag-and-drop of presently assigned orders directly onto an employed courier who is also the pending recipient of transfer orders from the same original courier. Selected orders are added to the pre-existing transfer and are thus integrated into the pickup courier's assigned post-pickup route with the goal of minimizing an increase in the pickup courier's route cost. The subject orders are immediately removed from the route of the transferring courier to be returned if the pickup is canceled by the pickup courier. This action is also performed when selected unassigned orders are dropped directly onto a portion of the pickup courier's route (i.e. the line connecting orders A and B). However, the selected orders shall instead be inserted specifically between orders A and B in a way that minimizes increase in route cost given this constraint.

The process is slightly modified for contract couriers as opposed to employee couriers. If the selected orders are currently assigned, and the manager drag-and-drops them directly onto a contracted courier (to whom the courier currently delivering the selected orders is also currently transferring), a new provisional transfer update bundle is created which adds the selected orders to the pre-existing assigned transfer and are thus integrated into the pickup courier's provisional post-pickup route with the goal of minimizing an increase in the pickup courier's provisional route cost. The subject orders are immediately removed from the route of the original courier transferring the orders, to be returned if the provisional route is rejected or the pickup is canceled by the second pickup courier. This action is also performed when selected unassigned orders are dropped directly onto a portion of the pickup courier's route (i.e. the line connecting orders A and B). However, the selected orders shall be provisionally inserted specifically between orders A and B in a way that minimizes increase in route cost given this constraint.

A first access point to this process 1900 comes from FIG. 11 (input Σ) by which it is noted that a courier has already been assigned a transfer order from another courier. Initially, a determination is made as to whether the courier has previously been offered a transfer update bundle, but has not yet accepted (operation 1802). If not, then the system creates a new transfer update bundle to integrate the carrier's previously assigned orders and the prior transferred orders (subroutine 1804). This transfer update bundle creation process 1804 may be implemented in a similar manner to the process described with respect to operation 1604 in FIG. 16. The difference is that to reject this offer only excludes the newly offered orders that would update the transfer, rather than both new and old.

Returning to FIG. 19, if the courier has previously been offered a transfer update bundle (operation 1902), then a further determination is made as to whether the orders presently offered for transfer update are also being transferred from the same original courier as the prior accepted transfer offer (operation 1906). If not, the transfer integration offer is not implemented by the system, the orders selected for transfer integration may be either rescinded or returned from the original courier, and, if rescinded, the status of the orders is changed to “unselected” so that they can be immediately reassigned by a system manager as indicated by the direction to FIG. 11 (input Ω).

If the transfer update orders offered for integration are from the same courier, then a slightly different algorithm is used to integrate additional transferred integration bundles into the proposed delivery contract (operation 1808). As above, this transfer integration bundle creation process 1804 may be implemented in a similar manner to the process described with respect to operation 1704 in FIG. 17. For example, in the context of management of couriers, orders, and routes through the order management GUI, the process is performed in response to a manager drag-and-drop of orders directly onto a contracted courier to whom the courier currently delivering the selected orders is also previously provisionally transferring. Selected orders are added to the pre-existing transfer update offer and are thus integrated into the second pickup courier's provisional post-pickup route with the goal of minimizing an increase in the pickup courier's provisional route cost. The subject orders are immediately removed from the route of the first courier transferring the orders, to be returned if the provisional transfer update route is rejected or the pickup is canceled by the pickup courier. This action is also performed when selected unassigned orders are dropped directly onto a portion of the pickup courier's route (i.e., the line connecting orders A and B). However, the selected orders shall be provisionally inserted specifically between orders A and B in a way that minimizes increase in the provisional transfer update route cost given this constraint.

The new transfer update bundle route offer immediately replaces the previous offered transfer update bundle route and continues to await the response of the subject contract worker courier. Once the system has either created a new transfer update assignment and route (operation 1906) or integrated transfer update orders into an existing offered transfer update bundle with a revised route for the carrier (operation 1908), the courier is presented with the transfer update bundle for acceptance and delivery and a revised route on the courier's mobile device (operation 1910). Note that a rejection of this offer by the contract pickup courier only excludes all offered transfer update orders, not the transfer orders that have already been accepted and assigned.

The process 1900 next determines whether the courier is an employee or a contractor (operation 1912). If the courier is an employee, the process for the employee courier immediately reverts to the standard bundle assignment and delivery process of FIG. 12 (input B). If, instead, the courier is a contractor, the process proceeds to formally offer the transfer update bundle to the contractor as a contract assignment (operation 1914). It should be noted that the additional flow from FIG. 15 (input S) may also be received at operation 1914 to offer a contract to the contractor courier at that point in the process of FIG. 19. From operation 1914, the process then determines whether the contract courier actually accepts the offer (operation 1916). If the contract courier accepts the offer, then the process immediately reverts to the standard bundle assignment and delivery process of FIG. 12 (input B). If the contract courier declines the offer, then the process for the courier immediately reverts to FIG. 12 (input C) for a determination of whether or not the contract courier has accepted other orders for delivery and proceeds from there. In addition, at this point a simultaneous process is initiated in FIG. 14 (input J) to retract the offered transfer orders and return the courier to the original transfer instructions offered. Further, if before the contract courier accepts the integration orders, the manager retracts the orders, the process could be redirected to FIG. 15 (input α) in the alternate scenario flowing from operation 1914 in FIG. 19.

As previously described, a system manager may decide that there is benefit to having one courier take orders from another courier that has already picked the orders up from a depot (e.g., quicker delivery, one courier has a better vehicle for completing delivery due to inclement weather, etc.). FIG. 20 depicts a flow process 2000 for courier actions when implementing an order bundle transfer from one courier to another. This part of the system may be called from numerous other parts of the platform previously described, e.g., FIG. 13 (input M), FIG. 16 (input U), and FIG. 19, input Z) which each described various implementations of transfer directives. The process for a courier receiving a transfer order to a second pickup courier begins at operation 2002 through which the courier is informed of the transfer and provided a route update to intercept the pickup courier who will be taking the orders. Next the transferring courier is directed to remain in the rendezvous location until the pickup courier arrives. Notably, this waiting could be cut short if the transfer order is canceled, for example, the pickup courier does not accept the transfer as indicated in operation 2006. In this case, the transferring courier may be returned to other processes as indicated by the optional flow to FIG. 14 (input J) where the orders are returned to the courier and they proceed to make deliveries.

If there is no change in directive, when the pickup courier arrives, the couriers physically transfer the orders and indicate within the application platform that the exchange is completed (operation 2008). The process continues with a determination whether the transferring courier still has transfer directions to transfer orders to other pickup carriers (operation 2010). This determination is also used in the event that a transfer order was canceled and orders were returned to the carrier in FIG. 14 (input O from operation 1410). If so, the courier is directed to the next transfer location (operation 2004). If not, the routine terminates and the courier is sent to the routine of FIG. 12 (input C) to continue deliveries on its assigned route or be assigned a new order bundle.

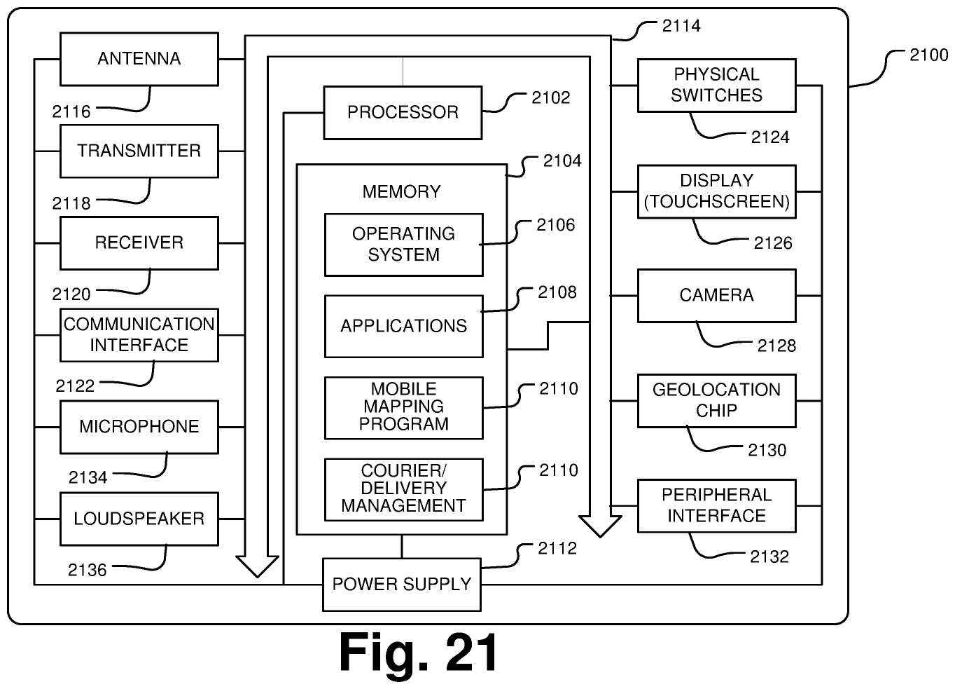

An exemplary mobile device 2100 for use within the network implementing the real-time delivery operation management system is depicted in FIG. 21. The mobile device 2100 includes a processor 2102 and memory 2104 as in any standard computing device. The processor 2102, memory 2104, and other components hereinafter described may interface via a system bus 2114. The system bus 2114 may be any of several types of bus structures including a memory bus or memory controller, a peripheral bus, a switched fabric, point-to-point connections, and a local bus. The memory 2104 generally includes both volatile memory (e.g., RAM) and non-volatile memory (e.g., ROM) on partitions of embedded MultiMediaController (eMMC) or Universal Flash Storage (UFS) memory chips. An operating system 2106 may reside in the memory 2104 and execute on the processor 2102. Exemplary operating systems may include the Android (Google) or iOS Apple) operating systems.

One or more application programs 2106 may be loaded into the memory 2104 for execution by the processor 2102 in conjunction with the operating system 2106. Exemplary applications may include electronic mail programs, scheduling programs, personal information management programs, word processing programs, spreadsheet programs, Internet browser programs, music file management programs, and photograph and video file management programs. The memory 2104 may further include a mobile mapping application 2110, which executes on the processor 2102 and interfaces with the Global Positioning System (GPS) or other geolocation chip 2130. The memory 2104 may also include a delivery operation management application 2111 according to the description herein for use by a courier or to receive and execute delivery requests and also by a delivery assignment manager if managing the system on a mobile device. The delivery operation management application 2111 may interface with the mobile mapping application 2110 and geolocation chip 2130 in order to effect the routing operations described herein.

The mobile device 2100 also has a power supply 2112, which may be implemented using one or more batteries. The power supply 2112 may also be from an external AC source through the use of a power cord or a powered data transfer cable connected with the mobile device 2100 that overrides or recharges the batteries. The power supply 2112 is connected to most, if not all, of the components of the mobile device 2100 in order for each of the components to operate.

In one embodiment, the mobile device 2100 may include communications capabilities, for example, the mobile device 2100 operates as a wireless telephone. A wireless device 2100 with telephone capabilities generally includes an antenna 2116, a transmitter 2118, and a receiver 2120 for interfacing with a wireless telephony network. Additionally, the mobile device 2100 may include a microphone 2134 and loudspeaker 2136 in order for a user to telephonically communicate. The loudspeaker 2136 may also be in the form of a wired or wireless output port for connection with a wired or wireless earphone or headphone.

The mobile device 2100 may connect with numerous other networks, for example, a wireless LAN (Wi-Fi) network, a wired LAN or WAN, Bluetooth, near field communication, GPRS, UMTS, LTE, 4G, 5G, or any other network via one or more communication interfaces 2122. The antenna 2116 or multiple antennae may be used for different communication purposes, for example, radio frequency identification (RFID), microwave transmissions and receptions, Wi-Fi transmissions and receptions, GPS transmissions and receptions, and Bluetooth transmissions and receptions, etc.

The mobile device 2100 further generally includes some type of user interface. As shown in FIG. 21, the mobile device 2100 may have a physical switches 2124 and a touchscreen display 2126. The physical switches 2124 may be provide for powering the device on or off, volume adjustment, activation or deactivation of an eccentric vibrator motor, biometric security identification, GUI manipulation (e.g., menu selection or navigation), data entry (e.g., a button keyboard), or numerous other possible functions. In addition to depicting information, the display 2126 may also be a touch screen display that allows for data entry by touching the display screen with the user's fingers to type or make input selections via a graphical interface or write letters and numbers directly on the display 2126 using a finger or a stylus.

The mobile device 2100 may also include one or more cameras 2128. In some implementations, cameras 2128 are provide on both the front and back faces of the mobile device 2128. Each camera 2128 may include one or more lenses, charge coupled devices, LED flashes or light sources, a shutter switch (either physical or presented in the GUI of the display 2126), and other camera hardware integrated with a software program for controlling the camera 2128 and storing images in the memory 2104.

In the embodiment depicted in FIG. 21, the mobile device 2100 includes a peripheral interface 2132, e.g., for connection with a power cord headphones, microphone, external loudspeaker, external memory, external battery, computer connection, etc. (It should be understood that connection of these external devices may also occur wirelessly (e.g., via Bluetooth) and that charging of the mobile device 1200 may be provided via induction as well. The peripheral interface may be directly coupled to the power supply 2112 for rapid response when actuated and for recharging the power supply 2112.

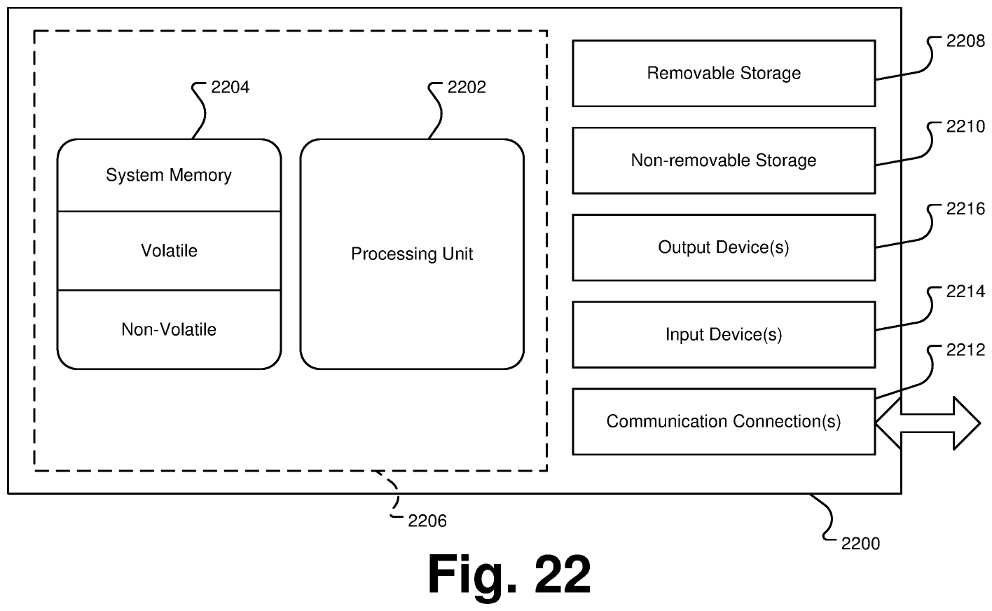

FIG. 22 illustrates an exemplary computer system or other processing device 2200 configured by the real-time delivery management system as described herein. In one implementation, the processing device 2200 typically includes at least one processing unit 2202 and memory 2204. Depending upon the exact configuration and type of the processing device 2200, the memory 2204 may be volatile (e.g., RAM), non-volatile (e.g., ROM and flash memory), or some combination of both. The most basic configuration of the processing device 2200 need include only the processing unit 2202 and the memory 2204 as indicated by the dashed line 2206.

The processing device 2200 may further include additional devices for memory storage or retrieval. These devices may be removable storage devices 2208 or non-removable storage devices 2210, for example, memory cards, magnetic disk drives, magnetic tape drives, and optical drives for memory storage and retrieval on magnetic and optical media. Storage media may include volatile and nonvolatile media, both removable and non-removable, and may be provided in any of a number of configurations, for example, RAM, ROM, EEPROM, flash memory, CD-ROM, DVD, or other optical storage medium, magnetic cassettes, magnetic tape, magnetic disk, or other magnetic storage device, or any other memory technology or medium that can be used to store data and can be accessed by the processing unit 2202. Additional instructions, e.g., in the form of software, that interact with the base operating system to create a special purpose processing device 2200, in this implementation, instructions for implementation of processes of the delivery management system, for example, as described with respect to FIGS. 10-20 herein, may be stored in the memory 2204 or on the storage devices 2210 using any method or technology for storage of data, for example, computer readable instructions, data structures, and program modules.

The processing device 2200 may also have one or more communication interfaces 2212 that allow the processing device 2200 to communicate with other devices. The communication interface 2212 may be connected with a network. The network may be a local area network (LAN), a wide area network (WAN), a telephony network, a cable network, an optical network, the Internet, a direct wired connection, a wireless network, e.g., radio frequency, infrared, microwave, or acoustic, or other networks enabling the transfer of data between devices. Data is generally transmitted to and from the communication interface 2212 over the network via a modulated data signal, e.g., a carrier wave or other transport medium. A modulated data signal is an electromagnetic signal with characteristics that can be set or changed in such a manner as to encode data within the signal.

The processing device 2200 may further have a variety of input devices 2214 and output devices 2216. Exemplary input devices 2214 may include a keyboard, a mouse, a tablet, and/or a touch screen device. Exemplary output devices 2216 may include a video display, audio speakers, and/or a printer. Such input devices 2214 and output devices 2216 may be integrated with the processing device 2200 or they may be connected to the processing device 2200 via wires or wirelessly, e.g., via IEEE 802.11 or Bluetooth protocol. These integrated or peripheral input and output devices are generally well known and are not further discussed herein. Other functions, for example, handling network communication transactions, may be performed by the operating system in the nonvolatile memory 2204 of the processing device 2200.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A real-time delivery operation management system implemented on a computer system comprising
a visual management interface that depicts product depots, couriers, pick-up locations, delivery locations, and courier route paths connecting one or more of the foregoing in real time overlaid on a map;
a selection tool that allows a user to select delivery locations through the visual management interface to add or remove delivery orders associated with respective delivery locations from the courier route paths;
an assignment management system that manages underlying courier assignment, order allocation and status, and real-time carrier routing information in response to user input through the selection tool; and
a telecommunications connection that transmits the courier assignment and real-time courier routing information to couriers participating in the system.

2. The system of claim 1, wherein the selection tool
allows a user to select one or more of the delivery locations on a first courier route path; and
allows a user to visually transfer the selected delivery locations from the first courier route path to a second courier route path; and
wherein the assignment management system reconfigures the second courier route path to include the selected delivery locations and reconfigures the first courier route path to remove the selected delivery locations.

3. The system of claim 1, wherein the selection tool
allows a user to select one or more of the delivery locations that are not on any of the courier route paths; and
allows a user to visually transfer the selected delivery locations from locations overlaid on map to the first courier route path; and
wherein the assignment management system reconfigures the first courier route path to include the selected delivery locations.

4. The system of claim 1, wherein the visual management interface is configured to allow the selection tool to dynamically, visually drag one or more selected delivery locations depicted on the map onto one of the carrier route paths and alters the one of the carrier route paths to include the one or more selected delivery locations in a revised carrier route path visually presented on the map.

5. The system of claim 4, wherein when the at least one of the selected delivery locations is initially assigned to and part of another of the carrier route paths, the another of the carrier route paths is altered by the visual management interface to remove the at least one of the selected delivery locations when it is included in the revised carrier route path.

6. The system of claim 4, wherein the at least one of the selected delivery locations is initially unassigned to any courier route path.

7. The system of claim 2, wherein
the visual management interface depicts a transfer route path between the first courier route path and the second courier route path; and
the assignment management system directs via the telecommunications connection a first courier on the first courier route path and a second courier on the second courier route path to follow the transfer route path to meet and transfer goods associated with one or more of the selected delivery locations from the first courier to the second courier before the first courier resumes delivery along the first courier route path and the second courier resumes delivery along the second courier route path.

8. The system of claim 1, wherein the assignment management system is configured to allocate delivery orders between employee couriers and contract couriers using a weighting algorithm that prioritizes employee couriers.

9. The system of claim 8, wherein the assignment management system offers a particular courier route path to a contract courier over the telecommunications connection, but only assigns the particular courier route path to the contract courier upon receipt of an acceptance of the particular courier route path by the contract courier over the telecommunications network.

10. The system of claim 1, wherein the assignment management system is configured to iteratively place new delivery orders on current route paths assigned to couriers and new route paths to be assigned to couriers, calculate route costs of all possible routes, and assign and move delivery orders between current and new route paths to minimize route costs.

11. A method for real-time delivery operation management implemented on a computer system configured to perform the following operations:
present a visual management interface that depicts product depots, couriers, pick-up locations, delivery locations, and courier route paths connecting one or more of the foregoing in real time overlaid on a map;
provide a selection tool within the visual management interface that allows a user to select delivery locations to add or remove delivery orders associated with respective delivery locations from the courier route paths;
manage underlying courier assignment, order allocation and status, and real-time carrier routing information in response to user input through the selection tool; and
transmit the courier assignment and real-time courier routing information via a telecommunications network to couriers.

12. The method of claim 11, wherein the selection tool further
allows a user to select one or more of the delivery locations on a first courier route path; and
allows a user to visually transfer the selected delivery locations from the first courier route path to a second courier route path; and
wherein the method further reconfigures the second courier route path to include the selected delivery locations and reconfigures the first courier route path to remove the selected delivery locations.

13. The method of claim 11, wherein the selection tool further
allows a user to select one or more of the delivery locations that are not on any of the courier route paths; and
allows a user to visually transfer the selected delivery locations from locations overlaid on map to the first courier route path;
and wherein the method further reconfigures the first courier route path to include the selected delivery locations.

14. The method of claim 11, wherein the visual management interface allows the selection tool to dynamically, visually drag one or more selected delivery locations depicted on the map onto one of the carrier route paths and alters the one of the carrier route paths to include the one or more selected delivery locations in a revised carrier route path visually presented on the map.

15. The method of claim 14, wherein when the at least one of the selected delivery locations is initially assigned to and part of another of the carrier route paths, the method further comprises altering the another of the carrier route paths by the visual management interface to remove the at least one of the selected delivery locations when it is included in the revised carrier route path.

16. The method of claim 14, wherein the at least one of the selected delivery locations are initially unassigned to any courier route path.

17. The method of claim 12 further comprising
depicting within the visual management interface a transfer route path between the first courier route path and the second courier route path; and
directing via the telecommunications connection a first courier on the first courier route path and a second courier on the second courier route path to follow the transfer route path to meet and transfer goods associated with one or more of the selected delivery locations from the first courier to the second courier before the first courier resumes delivery along the first courier route path and the second courier resumes delivery along the second courier route path.

18. The method of claim 11 further comprising allocating delivery orders between employee couriers and contract couriers using a weighting algorithm that prioritizes employee couriers.

19. The method of claim 18 further comprising offering a particular courier route path to a contract courier over the telecommunications connection, but assigning the particular courier route path to the contract courier only upon receipt of an acceptance of the particular courier route path by the contract courier over the telecommunications network.

20. The method of claim 11 further comprising
iteratively placing new delivery orders on current route paths assigned to couriers and new route paths to be assigned to couriers;
calculating route costs of all possible routes; and
assigning and moving delivery orders between current and new route paths to minimize route costs.
